(19) United States
(12) Patent Application Publication
(10) Pub. No.: US 2012/0057695 A1
(43) Pub. Date: Mar. 8, 2012

(54) CIRCUITS FOR MODULAR ARITHMETIC BASED ON THE COMPLEMENTATION OF CONTINUED FRACTIONS

(76) Inventors: Dejan Lazich, Stutensee (DE); Herbert Alrutz, Freiburg (DE); Christian Senger, Hockenheim (DE)

(21) Appl. No.: 12/440,340

(22) PCT Filed: Jun. 26, 2007
(86) PCT No.: PCT/EP07/05635

§ 371 Date: Aug. 31, 2009

(30) Foreign Application Priority Data
Sep. 7, 2006 (DE) 10 2006 042 513.8

(51) Int. Cl. H04L 9/28

(52) U.S. Cl. 380/28

(57) ABSTRACT

A method for calculating a modular multiplication of integers a and b or polynomials a(x) and b(x) for a modulus N. The method including (i) calculating a supplemental product continued fraction c=(ab+jN)/t by supplementing particular numerators of a product fraction (ab)/t represented as a continued fraction, and (ii) calculating a second supplemental product continued fraction r=(cd+kN)/t from a previously calculated modular remainder d=R_{N}[t²] and the calculated supplemental product continued fraction c.

### PRIORITY INFORMATION

This patent application claims priority from PCT patent application PCT/EP2007/005635 filed Jun. 26, 2007, which claims priority to German patent application 10 2006 042 513.8 filed Sep. 7, 2006, both of which are hereby incorporated by reference.

### FIELD OF THE DISCLOSURE

This disclosure relates generally to modular arithmetic, and more particularly to modular arithmetic based on supplementation of continued fractions.

### BACKGROUND OF THE INVENTION

### Public Key Cryptography

Public key cryptography (“PKC”), established by Diffie and Hellman in 1976, has become a standard method for the exchange of encrypted and signed data. In PKC systems, each communication subscriber has a secret private key and a public key. Any messages encrypted with the public key can only be decrypted with an associated private key. Similarly, signatures using a private key can only be verified with an associated public key. Therefore, secure communication may proceed without first exchanging a common secret between communication partners (i.e., the communication subscribers). Rather, communication partners merely need to obtain the correct and current public key for one another from a trustworthy public source, while keeping their own private keys confidential. In this way, the asymmetric PKC methods eliminate a basic problem of the classical symmetric crypto methods—i.e., the secure exchange of a shared secret key.

PKC methods are also used for following cryptographic tasks:
Password and identification systems—systems for authenticating access to data or facilities; i.e., for verifying whether somebody is the person he claims to be.
Non-repudiation—to prevent communication partners from later denying transactions which they have already performed during an information exchange.
Exchange of shared secrets—to facilitate the exchange of keys for subsequent symmetric cryptographic methods between the communication partners.
Generation of pseudo random numbers—to aid in the search for a suitable PKC-related pair of keys.
Bit commitment—to define certain crypto parameters which are binding for the communication partners.
Secret sharing—to facilitate in the joint safeguarding of secret information.
Zero knowledge proof—to convince one communication partner that another communication partner has a secret without revealing information about the secret itself.
   These tasks are realized by various cryptographic protocols which prescribe the exact sequence of individual actions and transactions of the communication partners. They allow for many practical applications together with a public key infrastructure, from the secrecy of messages to electronic payment systems and secure elections. These practical applications are realized more and more often by a direct embedding of PKC algorithms in integrated circuits (“ICs”).

Typically, PKC systems include mathematical one-way functions which are usually calculated by a sufficiently large number of repetitions of a certain mathematical operation on input data. For authorized parties knowing the number of repetitions (i.e., the secret key), the backward calculation of the input data is relatively simple. In contrast, the backward calculation for unauthorized parties which are not aware of the secret key is relatively difficult (i.e., practically impossible). One example of mathematical one-way functions is the exponentiation (i.e., repeated multiplication) in finite cyclic groups with its reversion (without knowledge of the secret key), the discrete logarithm.

In certain cyclic groups of a considerable size, the calculation of the discrete logarithm is relatively difficult. The search for the solution of the discrete logarithm in these groups has been termed the discrete logarithm problem (“DLOG problem”), and there are some PKC methods whose security is based on the difficulty of the DLOG problem (i.e., “DLOG method”). The security of the most noted PKC encryption and signature method, named the RSA method after its discoverers Rivest, Shamir and Adelman, depends on the difficulty of the factorization problem, which still today has not been solved.

For the practical implementation of the asymmetric crypto algorithms, modular arithmetic operations play a fundamental role, as will be described in more detail below, since the modular arithmetic (or remainder class arithmetic) constitutes a basis for the calculation in remainder class rings modulo N as well as in finite fields. If the natural number “N” is a prime number “p”, the arithmetic rules for the modular arithmetic define the rules for the calculation in prime fields “Φₚ” (or “GF(p)”).

In this context, constructions of encryption functions based on modular addition and basic modular multiplication can be disadvantageous because the encryption techniques defined in this manner can be broken with a manageable effort. In contrast, the exponentiation and its inversion, the discrete logarithm, may be very well suited.

In this manner, the conversion of an unencrypted text (plaintext) “U” can be described using a public key “Kₚ” of a communication device “E” by the equation

V=U^{Kp} mod N,

where the previously calculated numbers Kₚ and N are published by the communication device E. The decryption of the encrypted text (i.e., ciphertext) “V” is performed through the communication device E using the equation

U=V^{Ks} mod N,

where the previously calculated number “Kₛ” is a secret information (i.e., a secret key) held by the communication device E. However, such an encryption technique is only secure where the secret key is a sufficiently large number. The meaning of “sufficiently” in this context depends on the exact encryption algorithm used; however, examples of typical values for common methods will be provided below.

Modular arithmetic can be used to perforin the encryption and decryption of information as well as other cryptographic tasks for both integer and polynomials. For example, where the modulus polynomial “N(x)” is irreducible over Φₚ, where N(x)=p(x) and degree (p(x))=m∈N\{0} (i.e., p(x) cannot be expressed as a product of polynomials over Φₚ), the arithmetic rules for the modular arithmetic over polynomials defines the rules for the calculation in finite extension fields “Φₚm” (or “GF(p^{m})”). Here, the calculation is carried out with polynomials modulo p(x) and additionally in components modulo p (i.e., in Φₚ).

Apart from arithmetic in rings Z_{N} of integers modulo N, where N is not a prime number, and in finite fields Φₚ and Φₚm, it is also possible to use the group arithmetic of the elliptic and hyperelliptic curves. These group operations are composed of several arithmetic operations on the finite fields Φₚ or Φₚm. One example of such a method is disclosed in German Publication No. 69829967.

Notably, arithmetic operations are used because the security of the secret key crucially depends on its bit length. The RSA and DLOG methods have a common feature that they offer sufficient security only where very large numbers are used as private keys (i.e., secrets); e.g., 300 to 600 decimal places, a length of approximately 1000 to 2000 bits. Using these very large numbers, it is practically impossible to reconstruct the secret input data without knowing the secret key. In addition, it is practically impossible to reconstruct the secret key itself. However, where smaller key lengths are used, both the RSA and DLOG methods can be broken using certain algorithms (e.g., see Alfred J. Menezes et al., “Handbook of Applied Cryptography”, CRC Press Series on Discrete Mathematics and Its Applications, CRC Press, ISBN: 0-8493-8523-7, 1997.) or alternately by trying all possible secret keys (e.g., where the secret key is relatively small).

Although long private keys provide additional security, they also increase the length of the calculations for the one-way functions. As a result, computers calculating these one-way functions may need a larger processing capacity. Typically, present embedded systems do not have sufficient processing and storage capacities for rapidly calculating these one-way functions. Thus, there is the need for a PKC method that has a relatively high degree of security, while using relatively small key lengths—i.e., a higher security per each private key bit.

One approach to achieve this goal is to use Elliptic Curve Cryptography (“ECC”) or Hyper-Elliptic Curve Cryptography (“HECC”). Elliptic curves are defined as point sets over a base field determined by certain polynomial equations, for which the point addition (e.g., addition of two points), the point duplication and the multiplication of a point with a natural number can be defined. In this context, point addition and point duplication are composed of several operations of the base field. The multiplication of a point with a natural number in turn includes several point additions and point duplications. Such methods utilize the fact that points on an elliptic curve constitute a finite cyclic group with respect to the multiplication of a point with a natural number. Therefore, the DLOG problem may be transferred to the points on an elliptic curve. As applied to an EC-DLOG problem, due to the additional arithmetic level, all known methods typically fail to solve the DLOG problem where they are applied to the EC-DLOG problem, even for keys of a relatively small length. Therefore, it is possible to reduce the key length without hampering security levels. For example, it is generally recognized that an ECC method with private keys having a length of 160 bits delivers approximately the same security as the RSA method with private keys having a length of 1024 bits. In efforts to further shorten key lengths without reducing security, cryptography on hyperelliptic curves have been used.

This enhanced security per bit of the private key may unduly complicate the multiplication of a point with a natural number. Depending on the base field of the curve and the representation of its points, numerous operations in the base field are required for such a multiplication and in particular complex inversions. For this reason and due to the low processing capacity of embedded systems, one is dependent on extremely efficient realizations of the operations in the base field. Basically, these are operations of the modular arithmetic with long numbers whose software realizations in most cases are too expensive for embedded systems.

### Modular Arithmetic

The goal of modular arithmetic is to find a remainder R=R_{N}[n] (also noted as R=n mod N) of an integer n∈Z={ . . . , −2, −1, 0, 1, 2, . . . } with respect to another integer N∈Z\{0} other than 0 (the modulus), such that R∈N={0, 1, 2, . . . } is the one natural number which appears after subtraction of the greatest possible integer multiple of the number N of n. The following are three examples of how to calculate the remainder:

R₇[23]=2=3·7+2;

R₇[−23]=5=−4·7+5; and

R₋₇[23]=2=(−3)·(−7)+2.

According to Euclid's division theorem, exactly one pair having quotient q∈Z and remainder R∈N exists for n∈Z and N∈Z\{0}, such that

n=q·N+R (1)

where |N|>R≧0 (2)

is true. For a fixed value N∈Z\{0}, all values of R for n∈Z are found in the remainder class ring modulo N, which is designated Z_{N}={0, 1, 2, . . . , N−1}.

Some attributes of remainders may be derived from Euclid's division theorem. The most important of these attributes are as follows:

R_{N}[−n]=R_{N}[N−R_{N}[n]] (3)

R_{-N}[n]=R_{N}[n] (4)

R_{N}[j·N]=0 (5)

R_{N}[n+j·N]=R_{N}[n] (6)

R_{N}[n]=n, if N>n≧0 (7)

R_{N}[R_{N}[n]]=R_{N}[n] (8)

wherein n, j∈Z and N∈Z \{0}. As shown, the search for remainders of negative numbers and the search for remainders with respect to negative moduli with the two attributes (3) and (4) may be reduced to the positive case. Therefore, it is sufficient to merely consider the natural numbers.

Modular arithmetic may also be applied in an analogous way to the calculation with polynomials:

n(x)=n_{g-1}·x^{g-1}+n_{g-2}·x^{g-2}+ . . . +n₂·x²+n₁·x¹+n₀·x⁰ and

N(x)=N_{G-1}·x^{G-1}+x^{G-1}+N_{G-2}·x^{G-2}+ . . . +N₂·x²+N₁·x¹+N₀·x⁰,

where g and G∈N \{0} are respectively the lengths Λ(n(x)) and Λ(N(x)) of the particular polynomial, and where g−1 and G−1 are respectively the polynomial degrees—degree(n(x)) and degree(N(x)), where n_{g-1}≠0 and N_{G-1}≠0. The exponentiation x^{k} with a natural number k∈N corresponds to the k times repeated multiplication of the free variable x. A polynomial with coefficients which all have the value zero is termed zero polynomial 0.

The coefficients n₀, n₁, n₂, . . . , n_{g-1} as well as N₀, N₁, N₂, . . . , N_{G-1} of the respective polynomials originate from a given commutative ring—a set over which two arithmetic operations with certain attributes are defined (e.g. complex numbers X with complex addition and multiplication, real numbers P with real addition and multiplication, rational numbers O with their addition and multiplication, integers Z with their addition and multiplication, etc.).

The polynomials over the remainder class rings modulo N, i.e. over Z_{N}, are considered here as a basis.

The primary task of modular arithmetic with polynomials is to find a remainder polynomial R(x) of a polynomial n(x) with respect to another polynomial N(x)≠0. The remainder polynomial R(x) is a polynomial which is obtained by subtracting the greatest possible polynomial multiple of the modulus polynomial N(x) of n(x). In order to draw a distinction between scalar operations with elements from X, P, Θ, or Z, which are usually designated with +, −, and ·, and operations with polynomials, the polynomial addition, subtraction and multiplication are designated with !, ∀ and [symbol] , respectively. For the addition and subtraction of the polynomials, the carries (contrary to scalar + and −) are not taken into consideration. Thus, the calculation is performed component by component in Z_{N} and without carries. As a polynomial multiplication is composed of polynomial additions, the consideration of the carries is also omitted.

According to the Euclid's division theorem for polynomials, exactly one pair including a quotient polynomial q(x) and a remainder polynomial R(x) exists for two polynomials n(x) and N(x)≠0 with N_{G-1}=1, such that

n(x)=q(x) [symbol] N(x)!R(x) (9)

degree(N(x))>degree(R(x))≧0 (10)

is true, where R(x)=R_{N(x)}[n(x)].

For a fixed modulus polynomial N(x), all values of R(x) for n(x) are in the remainder class polynomial ring modulo N(x) over Z_{N}, which is designated Z_{N}[x]_{N(x)}.

The attributes of remainders over Z_{N}[x]_{N(x)} can be derived from the division theorem of Euclid for polynomials. The most important attributes are the following:

R_{N}[∀n(x)]=R_{N(x)}[N(x)∀R_{N(x)}[n(x)]] (11)

R_{∀N(x)}[n(x)]=R_{N(x)}[n(x)] (12)

R_{N(x)}[j(x) [symbol] N(x)]=0 (13)

R_{N(x)}[n(x)!j(x) [symbol] N(x)]=R_{N(x)}[n(x)] (14)

R_{N(x)}[n(x)]=n(x), if degree(N(x))>degree(n(x))≧0 (15)

R_{N(x)}[R_{N(x)}[n(x)]]=R_{N(x)}[n(x)] (16)

where n(x), j(x)∈Z_{N}[x]_{N(x)}, N(x)∈Z_{N}[x]_{N(x)}\{0} and ∀N(x)=0∀N(x).

Apart from the determination of remainders of integers and polynomials (frequently termed “modular reduction”), it is frequently required in modular arithmetic to calculate remainders of particular arithmetic functions. For integers, these functions are composed of arithmetic basic operations such as +, −, · and exponentiation with a natural number (e.g. R_{N}[n₁+n₂], or R_{N}[n₁·n₂]; n₁, n₂∈Z). For polynomials over Z_{N}[x]_{N(x)} this corresponds to the operations ! (i.e., polynomial addition), ∀ (i.e., polynomial subtraction), [symbol] (i.e., polynomial multiplication) and the exponentiation with a natural number (e.g. R_{N(x)}[n₁(x)∀n₂(x)], or R_{N(x)}[n(x)^{k}]; n(x), n₁(x), n₂(x)∈Z_{N}[x]_{N(x)}, k∈N)).

The general rules for the calculation of the remainders of arithmetic functions, which are composed of operations with integers, are as follows:

$$\begin{matrix}\begin{matrix}{R}_{N} [ {n}_{1} + {n}_{2} ] = {R}_{N} [ {R}_{N} [ {n}_{1} ] + {R}_{N} [ {n}_{2} ] ] \\ = {R}_{N} [ {n}_{1} + {R}_{N} [ {n}_{2} ] ] \\ = {R}_{N} [ {R}_{N} [ {n}_{1} ] + {n}_{2} ]\end{matrix} & \begin{matrix}( 17 A ) \\ ( 17 B ) \\ ( 17 C )\end{matrix} \\ \begin{matrix}{R}_{N} [ {n}_{1} \cdot {n}_{2} ] = {R}_{N} [ {R}_{N} [ {n}_{1} ] \cdot {R}_{N} [ {n}_{2} ] ] \\ = {R}_{N} [ {n}_{1} \cdot {R}_{N} [ {n}_{2} ] ] \\ = {R}_{N} [ {R}_{N} [ {n}_{1} ] \cdot {n}_{2} ]\end{matrix} & \begin{matrix}( 18 A ) \\ ( 18 B ) \\ ( 18 C )\end{matrix} \\ {R}_{N} [ {n}^{k} ] = {R}_{N} [ {{R}_{N} [ n ]}^{k} ] , & ( 19 )\end{matrix}$$

where n, n₁, n₂ ∈Z, k∈N and N∈Z \{0}.

The general rules for the calculation of the remainders, which are composed of operations with polynomials over Z_{N}[x]_{N(x)}, are as follows:

$$\begin{matrix}\begin{matrix}{R}_{N ( x )} [ {n}_{1} ( x ) ! {n}_{2} ( x ) ] = {R}_{N ( x )} [ {n}_{1} ( x ) ] ! {R}_{N ( x )} [ {n}_{2} ( x ) ] \\ = {R}_{N ( x )} [ {R}_{N ( x )} [ {n}_{1} ( x ) ] ! {R}_{N ( x )} [ {n}_{2} ( x ) ] ] \\ = {R}_{N ( x )} [ {n}_{1} ( x ) ! {R}_{N ( x )} [ {n}_{2} ( x ) ] ] \\ = {R}_{N ( x )} [ {R}_{N ( x )} [ {n}_{1} ( x ) ] ! {n}_{2} ( x ) ]\end{matrix} & \begin{matrix}( 20 A ) \\ ( 20 B ) \\ \begin{matrix}( 20 C ) \\ ( 20 D )\end{matrix}\end{matrix} \\ \begin{matrix}{R}_{N ( x )} [ {n}_{1} ( x ) {n}_{2} ( x ) ] = {R}_{N ( x )} [ {R}_{N ( x )} [ {n}_{1} ( x ) ] {R}_{N ( x )} [ {n}_{2} ( x ) ] ] \\ = {R}_{N ( x )} [ {n}_{1} ( x ) {R}_{N ( x )} [ {n}_{2} ( x ) ] ] \\ = {R}_{N ( x )} [ {R}_{N} [ {n}_{1} ( x ) ] {n}_{2} ( x ) ]\end{matrix} & \begin{matrix}( 21 A ) \\ ( 21 B ) \\ ( 21 C )\end{matrix} \\ {R}_{N ( x )} [ {n ( x )}^{k} ] = {R}_{N ( x )} [ {{R}_{N ( x )} [ n ( x ) ]}^{k} ] , & ( 22 A ) \\ {R}_{x} {k}_{- 1} [ {x}^{m} ] = {x}^{Rk [ m ]} , & ( 22 B )\end{matrix}$$

where n(x), n₁(x), n₂(x)∈Z_{N}[x]_{N(x)}, k∈N, m∈N\{0} and N∈Z, \{0}.

In comparison to the modular reduction of the larger operand, the modular addition R_{N}[a+b], a, b∈Z and the modular subtraction R_{N}[a−b] over the integers can be classed as not being more complicated since intermediate results are generated by addition and subtraction which have the same order as the larger operand (the orders relate to absolute values). For example, the effort for calculating R₁₀₃[38571+99]=R₁₀₃[38670] is not greater than the effort for calculating R₁₀₃[38571].

If additionally the modulus and the larger operand have the same order, the required modular addition (subtraction) is trivial, since merely a small multiple of the modulus has to be subtracted. This can be performed by repeated subtraction of the modulus. For example: R₁₀₂₂₃[38571+99]=R₁₀₂₂₃[38670]=38670−3·10223=8001. The modular addition of two representatives a and b of a remainder class modulo N (where a<N and b<N is true), which satisfy the inequality 0≦a+b≦2·(N−1), is particularly simple. Thus, at the most one straightforward subtraction of N is sufficient for the required modular reduction.

However, a significant problem arises where one of the operands is considerably larger than the modulus because a very large number of subtractions may have to be performed. For example, where R₁₀₃[38571+99]=R₁₀₃[38670]=38670−375·103=45, 103 would have to be subtracted 375 times, which is not practical. In contrast, a solution may be obtained quicker by dividing 38670 by the modulus 103. However, this method has a relatively low speed for larger numbers as compared to using the trivial reduction.

In modular arithmetic over polynomials, the modular addition R_{N(x)}[a(x)!b(x)] and the modular subtraction R_{N(x)}[a(x)∀b(x)], a(x), b(x)∈Z[x] produce the same results as the basic operations ! and ∀ itself, where degree(a(x))<degree(N(x)) and degree(b(x))<degree(N(x)). Where the longer operand is longer than the modulus polynomial, modular addition and subtraction are just as complex as the modular reduction of the longer operand. This is because no carries are generated with a component-wise addition and subtraction in the execution of the operations ! and ∀. However, a substantial problem is posed where one of the operands is substantially longer than the modulus since a very large number of subtractions may have to be performed.

In contrast to the modular addition and subtraction, the modular multiplication (R_{N}[a·b] or R_{N(x)}[a(x) [symbol] b(x)]) and exponentiation (i.e., exponentiation with a natural number (R_{N}[a^{k}] or R_{N(x)}[a(x)^{k}] with k∈N\{0, 1})) produces intermediate results which may reach a multiple of the length of the operands and of the modulus. For example, the inequality 0≦a·b≦(N−1)² is applied, where a and b are two representatives of a remainder class modulo N, and where a<N and b<N. As can be seen, the reduction by repeated subtraction of the modulus is practically infeasible since up to (N−1) subtractions may be necessary. For example, R₃₁₂[111·256]=R₃₁₂[28416]=28416−91·312=24. Here, the multiple 91 is too large to gain the result by repeated subtraction of the modulus.

The complexity of the required modular reduction in modular multiplication and exponentiation substantially increases, thus overcomplicating the separate method (e.g., multiplication or exponentiation with a natural number and subsequent reduction). Where large exponents are used, the separate modular exponentiation becomes practically infeasible.

The modular exponentiation may be reduced to the multiple modular multiplications. For example, according to the S&M (square-and-multiply)method, all radix powers of the exponent are calculated, then the multiplications are realized which are necessary between these radix powers.

The modular division may be reduced to the previously defined operations with the aid of “Fermat's little theorem”. Under this theorem, the (N−2)nd power of each element of a finite field is the modular inverse of exactly the element. Using this procedure the modular inversion and hence also the modular division can be reduced to the multiple execution of the modular multiplication.

The modular exponentiation and the modular division (inversion) therefore are reduced to the multiple performance of the modular multiplication. The main problem of the long-numbered modular multiplication is the modular reduction, which—with a split procedure (reduction after multiplication)—corresponds to a general modular reduction of much larger numbers than the modulus and may be very extensive. Only an algorithmically concurrent execution of multiplication and modular reduction yields utilizable methods. Numerous solution strategies are known in the art that range from more or less exact techniques for estimating the quotient q, up to sophisticated mathematical transformations which only deliver a correct result for the modular reduction or multiplication by a suitable inverse transformation. The selection of these strategies will be discussed below in further detail.

### Existing Approaches

As mentioned above, a crucial operation for the effectuation of cryptographic methods is the calculation of the quantity R_{N}[a^{e}] which can be reduced to the modular multiplication. Using these methods, the particular variables for encryptions which are secure in view of the today's standard encryptions can have a length of more than 1000 bits.

Previous approaches for a fast calculation of this quantity primarily concentrate on an acceleration of the exponentiation realized as a chaining of multiplications. This is why there are approaches to accelerate the above-mentioned S&M method, which, by clever combination of multiplications, considerably reduces the number of multiplications required for calculating a high power, e.g., by its parallelization. This, however, involves a high hardware complexity and in particular the necessity to provide a large number of registers for storing the intermediate results.

Another approach disclosed in German Publication No. 69633253 to Brickel et al, accelerates the S&M method by reducing the number of multiplications. However, this method requires pre-calculation of numerous constants, and therefore substantially increases the space requirements for the memory.

An alternative method, which is also disclosed in the '253 publication to Bricket et al., is to lower the number of required multiplications by skillfully selecting the exponents. The criterion for this is the Hamming weight of the corresponding exponent. However, disadvantageously the space from which this component of the key is selected is reduced, enlarging the vulnerability in view of a “brute force” approach.

In summary, the aforesaid approaches for accelerating the S&M method may disadvantageously (i) indirectly weaken of the crypto algorithm, and (ii) place such high demands on the memory requirements during their implementation that they cannot be used to their fullest extent particularly in embedded systems.

In another popular approach, where identical operands represents the modular exponentiation, a number r>N is selected which is coprime to modulus N; i.e., gcd(r, N)=1. The integers r⁻¹ and N⁻¹ are calculated with the Extended Euclidean Algorithm, such that r·r⁻¹+N·N⁻¹=1 and R_{N}[r·r⁻¹]=1; Rᵣ[N·N⁻¹]=1 applies. The Montgomery product M_{N,r}[n₁·n₂] of natural numbers n₁ and n₂ is defined by M_{N,r}[n₁·n₂]=R_{N}[n₁·n₂·r⁻¹]. With the aid of an additional inverse transformation, which also represents a Montgomery product, the modular multiplication R_{N}[n₁·n₂] and can be expressed as follows:

R_{N}[n₁·n₂]=M_{N,r}[M_{N,r}[n₁·n₂]·R_{N}[r²]] (23A)

The Montgomery product itself, can be calculated as follows:

M_{N,r}[n₁·n₂]=c

where c<N, and

M_{N,r}[n₁·n₂]=c−N where c≧N,

where

c=(n₁·n₂+N·Rᵣ[n₁·n₂·N⁻¹])/r (23B)

If number r is selected so as to be a power of two (i.e. r=2^{k}>N; k∈N), the division by r and the reduction Rᵣ[ ] in (23B) becomes relatively simple (e.g., by shifting k places, or removal of k LS-bits) and negligible with respect to the three remaining non-modular multiplications in (23B) (e.g., n₁·n₂=b, N·Rᵣ[ ] and b·N⁻¹), and to a non-modular addition. Thus, a modular multiplication is replaced by three straightforward (non-modular) multiplications and a straightforward addition using the Montgomery method.

In the practice of cryptographic applications with a k-bit modulus N, r=2^{k} presents itself, as the modulus used is customarily a large prime number or the product of two large prime numbers, i.e. a quantity for which gcd(r, N)=1.

The advantage of the technique results from the fact that the modular exponentiation R_{N}[a^{e}], which usually has to be performed, may be carried out as log₂e when Montgomery products are used. However, the execution of an inverse transformation is still required at the end.

A further advantage of the Montgomery technique is that some of the necessary arithmetic operations can be calculated in advance (i.e., during preprocessing). For example, a system for carrying out modular arithmetic is disclosed in U.S. Pat. No. 5,499,299. The method in the '299 patent is based on the Montgomery method, which in this case is accelerated by using previously calculated values which are tabulated in a lookup table. However, this implementation may substantially increase the demand on the memory. Therefore the use of embedded systems becomes problematic.

German Patent No. 3,631,992 discloses a related approach that uses a look-ahead method for the Z_{N} arithmetic. Similarly, German Publication No. 10107376 discloses an approach that uses a look-ahead method for the arithmetic on GF(2ⁿ). German Publication No. 69818798 also discloses an approach for accelerating the Montgomery method using bit manipulation.

Disadvantageously, systems based on the Montgomery method are only applicable for coprime numbers r and N. Additionally, the acceleration of the calculations typically comes at the expense of increased memory requirements.

Typically, to accelerate the performance of modular arithmetic operation and in particular of modular multiplication, is has proven advantageous to provide special hardware solutions (i.e., circuits) in combination with software implementations. Such an “ideal” circuit should have the following attributes:
Completeness—the ability to calculate all five modular basic operations addition, subtraction, multiplication, inversion (division) and exponentiation with a natural number using either integers or polynomials.
PKC universality—the ability to use RSA, ECC and HECC (i.e., the circuit should be suitable for remainder class rings Zₘ as well as prime fields Φₚ and extension fields Φₚm, in particular binary extension fields Φ₂m).
Scalable—not being limited to certain operand lengths and certain curve parameters.
Conformity—ability to support all known cryptography standards.
Synthesization in IC technology—the ability for implementation using standard components of conventional highly integrated circuits synthesized in the semicustom design.
Straightforwardness—the ability to perform each modular basic operation with a number of clock cycles which are as low as possible.
High clock rates—the ability to use high clock rates.
Space-saving—adapted to be in a circuit embedded in the IC.
Energy efficient—low power consumption of the embedded circuit.
Flexibility in terms of Implementation—the ability to be used as a discrete circuit, as a circuit controlled by a microcontroller, or as a pure software module for the microcontroller.
Universality in terms of implementation—larger non-specific sections of the circuit should also be employed for other frequently used crypto algorithms.
Resistance against attacks—having resistance against implementation and hardware attacks, in particular against all known side channel attacks that have been recently discovered (e.g., in the last years).

One example of such a circuit (e.g., a processor) is disclosed in the previously referenced '992 patent. The disclosed processor implements the modular multiplication by a series of additions to optimize the RSA method; i.e., it is not universal in PKC.

Another example of a processor allowing a hardware-based execution of a Montgomery multiplication in a specially designed co-processor is disclosed in U.S. Pat. No. 5,961,578.

Another example of a modular multiplier circuit and a crypto system are disclosed in German Patent Application No. 10 2005 028 518. This circuit is distinguishable in that a Montgomery multiplier contained therein works with a bit length which is adapted to the multiplication that is to be performed. This contributes to an enhancement of the security and to a shortened calculation time.

### SUMMARY OF THE INVENTION

The product a·b, which generally is much larger than the modulus N, may be initially reduced step-by-step (K times) during its calculation by dividing by the radix ρ (e.g., shifting by one digit place). Thus, a trivial reduction is made possible since the result (a·b)/ρ^{K} approaches N as closely as possible. Where the product fraction (a·b)/ρ^{K} is an integer, the modular product R_{N}[a·b] may be obtained immediately by a trivial reduction, in the course of which a small multiple λ≧0 of the modulus may be subtracted, and after a similar inverse transformation R_{N}[(R_{N}[a·b]/ρ^{K})·ρ^{2K}]. However, since product fraction (a·b)/ρ^{K} is rarely an integer (e.g., in exceptional cases), there is the need to prevent the intermediate results in the calculation of (a·b)/ρ^{K} from appearing as truly rational numbers for which the rules of modular arithmetic do not apply. This is why the intermediate results in the calculation of (a·b)/ρ^{K} are constantly supplemented, so that at the end a supplemented product fraction E_{N}(a·b/ρ^{K}) results as an integer. However, using this supplementation, it should be considered that the result is available in a special form E_{N}(a·b/ρ^{K})=(a·b+j·N)/ρ^{K}∈N; j∈N. Notably, in this case the correct result R_{N}[a·b] may be obtained by an identical inverse transformation and a subsequent trivial reduction. The presentation of (a·b)/ρ^{K} in the form of a finite continued fraction allows to identify the conditions and the supplementation rules resulting in the above special form, and hence to use the so introduced continued fraction transformation in the calculation of the modular multiplication.

As compared with other transformations such as the Montgomery transformation or Fast Fourier transformation, the continued fraction transformation may be advantageously exploited in the realization in integrated circuits. Thus, this method is not subject to restrictions which are assumed for the Montgomery transformation, for example, which can only be performed for numbers r coprime to modulus N. In comparison with the Fourier transformation and the direct techniques for modular multiplication (which do not require any inverse transformation), the continued fraction transformation can be used with low computing time in the calculations and number lengths which are usual in PKC. Moreover, the introduced continued fraction transformation may be calculated with a circuit both for integers and polynomials. Thus, the essential postulation of a complete circuit is fulfilled.

In the following detailed description, the symbols for natural numbers and integers are marked in bold print, whereas individual digits (numbers) for a radix p (number base) appear in normal type face.

A natural number a∈N (symbolically presented) may be quantitatively indicated in weighted form

a=a_{K-1}·ρ^{K-1}+a_{K-2}·ρ^{K-2}+ . . . +a₂·ρ²+a₁·ρ¹++a₀,

or shorter, in radix presentation

a=(a_{K-1}a_{K-2} . . . a₂a₁a₀)_{ρ}

with aₖ∈{0, 1, . . . , ρ−1}; k=0, . . . , K−1 being the associated digits for the radix p. In the concrete case for ρ=10, e.g. 321 can be represented as 3·10²+2·10¹+1·10⁰. For integers, it is indicated in both forms with a sign (+ or −) where a>0 or a<0 (absence of sign means +, as usual). The number length of a (in digits) is designated Λ_{ρ}(a). Where a_{K-1}≠0 and aₖ=0 for all k>K−1, then Λ_{ρ}(a)=K∈N\{0}.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1A shows a product continued fraction (a·b)/ρ^{K} for K=K presented by digits of the integer a with the length Λρ(a)=K digits with respect to the radix ρ;

FIG. 1B shows a generation of a product continued fraction by fragmenting the integer a (which is indicated in weighted form);

FIG. 2A shows a supplementation of particular numerators in equation (24). The symbol i|n means that the integer i divides the integer n, whereas iΦn means that i does not divide the integer n;

FIG. 2B shows an evaluation of the supplemented continued fraction E_{N}(a·b/ρ^{K}) in the form of a recursion (25) with the supplementation function (26);

FIG. 2C shows a supplemented product continued fraction E_{N}(a·b/ρ^{K}) presented as continued fraction (27);

FIG. 3 shows a calculation of the continued fraction transformation where ρ=10; in particular, FIG. 3B shows a product continued fraction and supplemented product continued fraction; FIG. 3C shows a calculation of the supplemented product continued fraction and the continued fraction transformation presented as a method of long division; and FIG. 3D shows a verification according to equations (29) and (30);

FIG. 4 shows a calculation of the continued fraction inverse transformation; in particular, FIG. 4A shows the example from FIG. 3A; FIG. 3B shows a direct inverse transformation; FIG. 3C shows an inverse transformation with the continued fraction inverse transformation; FIG. 4D shows a continued fraction inverse transformation presented as a method of long division; and FIG. 4E shows a verification according to equations (29) and (30);

FIG. 5 shows a calculation of the binary continued fraction transformation; in particular, FIG. 5A shows the calculation in FIG. 3 where ρ=2; FIG. 5B shows a continued fraction transformation presented as a method of long division; FIG. 5C shows a direct inverse transformation with ρ=10 (for the verification of the result);

FIG. 6 shows a calculation of the modular multiplication with the continued fraction transformation; In particular, FIG. 6A shows an example for polynomials from Z₂[x]ₚ₍ₓ₎; FIG. 6B shows a product continued fraction and supplemented product continued fraction; FIG. 6C shows a calculation of the supplemented product continued fraction and of the continued fraction transformation presented as method of long division; and FIG. 6D shows a direct inverse transformation (for the verification of the result);

FIG. 7 shows a procedure for the calculation of operation chains in modular arithmetic with and without transition into the space of the transformed entity;

FIG. 8 illustrates a circuit for the calculation of the numerator Z₀′ in the supplemented product continued fraction (27);

FIG. 9A illustrates a multiplier for two 1-digit inputs (aᵢ)_{ρ} and (bⱼ)_{ρ};

FIG. 9B illustrates an adder that receives a 1-digit input (E)_{ρ}, three 2-digit inputs for (p₁p₀)_{ρ} and (s₁s₀)_{ρ} from two multipliers, and carries (c₀ c₁)_{ρ} from a preceding adder, and provides a starting digit O and the carries o₁ and o₂ for the next adder;

FIG. 9C shows a digit structure of the addition with greatest possible input values with examples for ρ=10 and ρ=2;

FIG. 10 illustrates a circuit for the calculation of the numerator Z₁′ in the supplemented product continued fraction (27);

FIG. 11 illustrates a circuit for the calculation of an arbitrary numerator Zₘ′ in the supplemented product continued fraction (27);

FIG. 12 illustrates a general parallel circuit for the calculation of the supplemented product continued fraction E_{N}(a·b/ρ^{K}) or E_{N(x)}(a(x)·b(x)/x^{K});

FIG. 13 illustrates an adder including two chained full adders with a control input for the selection of the addition form: where the use of a “1” at the control input G/P integers for ρ=2 are added up (under consideration of the carries), where the use of a “0” at the control input G/P binary polynomials over Z₂[x]_{N(x)} are added up (without considering the carries), corresponding to an XOR gate with three inputs;

FIG. 14 illustrates a binary parallel circuit for the calculation of the supplemented product continued fraction E_{N}(a·b/2^{K}) or E_{N(x)}(a(x)·b(x)/x^{K}) with odd modulus (N₀=1);

FIG. 15 illustrates a binary parallel circuit for the calculation of the supplemented product continued fraction E_{N(x)}(a(x)·b(x)/x^{K}) with odd modulus (N₀=1);

FIG. 16 illustrates a general serial-parallel circuit for the calculation of the supplemented product continued fraction E_{N}(a·b/ρ^{K}) or E_{N(x)}(a(x)·b(x)/x^{K}), where the digits of the operand a are indicated in the starting position;

FIG. 17 illustrates a binary serial-parallel circuit for the calculation of the supplemented product continued fraction E_{N}(a·b/2^{K}) or E_{N(x)}(a(x)·b(x)/x^{K}) with odd modulus (N₀=1), where the bits of the operand a are shown in the starting position;

FIG. 18 illustrates a binary serial-parallel circuit for the calculation of the supplemented product continued fraction E_{N(x)}(a(x)·b(x)/x^{K}) (for polynomials if N₀=1), where the bits of the operand a are shown in the starting position;

FIG. 19 illustrates a binary serial-parallel circuit for the calculation of the supplemented product continued fraction E_{N}(a·b/2^{K}) or E_{N(x)}(a(x)·b(x)/x^{K}) with odd modulus (N₀=1) segmented in pipeline stages;

FIG. 20 shows structural diagrams of the binary serial-parallel circuit for the calculation of the supplemented product continued fraction; in particular, FIG. 20A shows a structure based on registers; and FIG. 20B shows a structure based on MAT cells;

FIG. 21 illustrates a pipeline stage of the binary serial-parallel circuit for the calculation of the supplemented product continued fraction;

FIG. 22 illustrates a final pipeline stage of the binary serial-parallel circuit for the calculation of the supplemented product continued fraction with an extension of the arithmetic unit (VAE);

FIG. 23 illustrates a connection of the control unit with the first pipeline stage and a MAT cell of the binary serial-parallel circuit for the calculation of the supplemented product continued fraction;

FIG. 24 shows the principle of the clock distribution in the binary serial-parallel circuit for the calculation of the supplemented product continued fraction;

FIG. 25 illustrates a pipeline stage of the binary serial-parallel circuit with multiplexers for the additional calculation of the modular addition and subtraction;

FIG. 26 illustrates a final pipeline stage of the binary serial-parallel circuit with multiplexers and extension of the register Reg b for the additional calculation of the modular addition and subtraction;

FIG. 27 shows the register structure of the binary serial-parallel circuit for the calculation of the supplemented product continued fraction extended for the calculation of the modular addition and subtraction; and

FIG. 28 illustrates a binary serial circuit for the calculation of the supplemented product continued fraction E_{N}(a·b/2^{K}) or E_{N(x)}(a(x)·b(x)/x^{K}) with odd modulus (N₀=1).

### DETAILED DESCRIPTION OF THE INVENTION

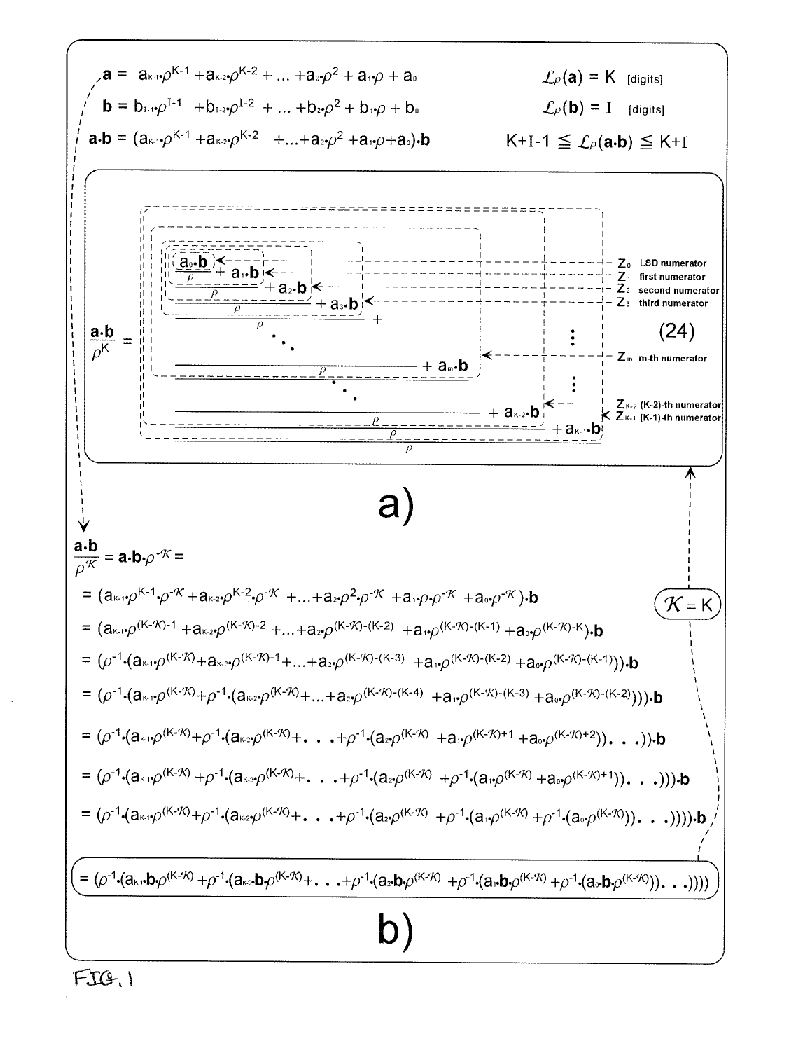

FIG. 1A shows one embodiment of a method for transferring a product a·b into a special product fraction (a·b)/t, where “a” and “b” are integers and members of the set Z; i.e., a, b∈Z. As shown in the framed portion of FIG. 1A, the special product fraction (a·b)/t has a radix power t=ρ^{K}; K∈N\{0} for K=K. For simplicity, one of the operands, for example “a” where Λ_{ρ}(a)=K, is broken down in a weighted form with respect to a radix ρ, as indicated in the first line of FIG. 1A.

FIG. 1B shows a segmentation of the presentation, i.e. a product continued fraction (24) (see FIG. 1A), for K=K. As shown in the first three lines of FIG. 1B, exponents of the radix power t=ρ^{K}; K∈N\{0} and of the form of the operand a, which are weighted with radix ρ, are combined. Subsequently and iteratively, ρ⁻¹ is factorized in the m-th step from the elements of the terms in each iteration, whereby the continued fraction is presented in an algebraic notation without the use of fraction bars at the end of the iteration on reaching the digit a₀.

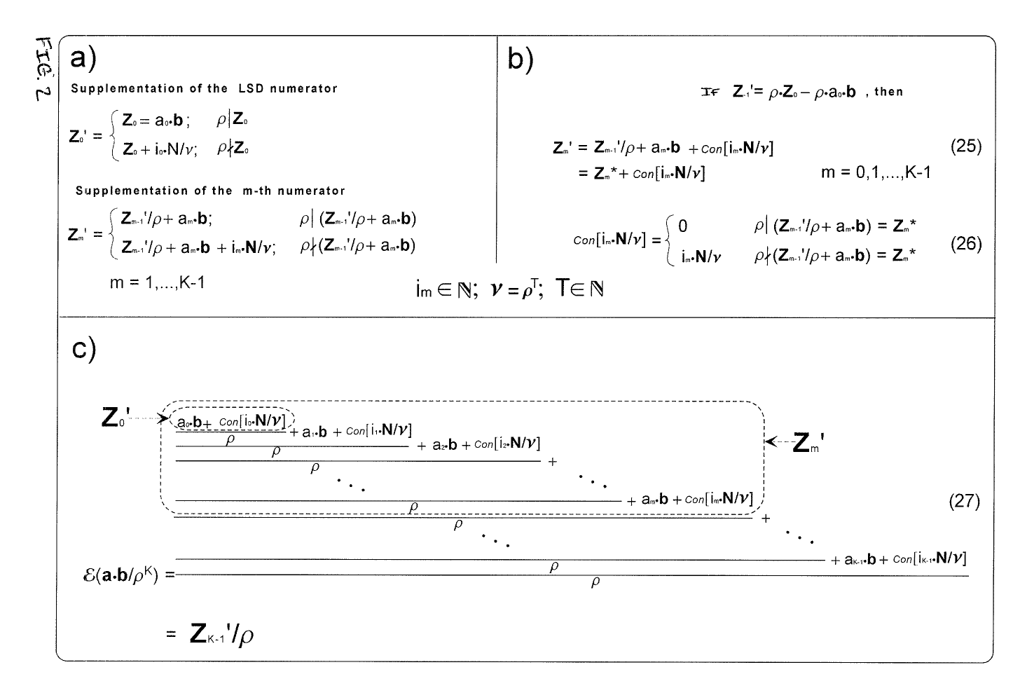

Referring to FIGS. 2A-2C, while any arbitrary numbers may be presented as a product continued fraction, the result of a product continued fraction may be a truly rational number (a·b)/ρ^{K}∈Θ, for which the modular arithmetic is undefined. It is therefore necessary to supplement the particular numerators Z₀, Z₁, . . . , Z_{K-1} in the stages of the product continued fraction (24) to supplemented numerators Z₀′, Z₁′, Z₂′, . . . , Z_{K-1}′ in such a manner that a supplemented product continued fraction, designated with E_{N}(a·b/ρ^{K}), is, for example, always an integer.

This is possible using a straightforward recursion, as illustrated in FIGS. 2A to 2C where K=K. The supplementation of the numerator Z₀=a₀·b belonging to a least significant digit a₀ is calculated for the starting value. Thus, it is determined whether the radix p divides the numerator Z₀. Referring to the top half of FIG. 2A, Z₀′=Z₀ where the radix p divides the numerator Z₀. Where the radix p does not divide the numerator Z₀, a supplementation term e₀=i₀·N/ν is added to Z₀ with the modulus N to obtain Z₀′. Referring to the lower half of FIG. 2B, the supplementation of the m-th numerator is similarly calculated, paying attention that in each case the carry from the (m−1)-th numerator is considered. The number iₘ∈N is termed the m-th supplementation factor and the number ν=ρ^{T}∈N\ {0}; T∈N is termed modulus divisor.

In a generalized manner, a recursive procedure may be defined by assuming a suitable “Z₋₁”. Using the supplementation function Con(iₘ·N/ν) in FIG. 2B, the evaluation of the supplemented product continued fraction E_{N}(a·b/ρ^{K}) is presented in the form of a single recursion, which may be presented as a supplemented product continued fraction (27), as illustrated in FIG. 2C. The numerators Z₀′, Z₁′, Z₂′, . . . , Z_{K-1}′ for K=K in the steps of the supplemented product continued fraction E_{N}(a·b/ρ^{K}) are supplemented such that they can be divided by ρ, thus E_{N}(a·b/ρ^{K})∈Z is, for example, always an integer.

The individual supplementation factors are determined according to the following procedure. The m-th non-supplemented numerator Zₘ*, the modulus N and the value N′ divided by the modulus divisor are initially transformed into their digit representations, where the length of the respective representations according to the basis ρ are given by Λρ(Zₘ*)=ξ(m), Λρ(N)=μ and Λρ(N′)=Λρ(N/ν)=μ−T; ν=ρ^{T}∈N\{0}. For the radix specifications of Zₘ*=Zₘ₋₁/ρ+aₘ·b, N and N′ in equations (25) and (26) (see FIG. 2B) the following is true:

Zₘ*=(z_{m,ξ(m)-1}*z_{m,ξ(m)-2}* . . . z_{m,1}*z_{m,0}*)_{ρ};

N=(N_{μ-1}N_{μ-2} . . . N₁N₀)_{ρ}; and

N′=N/ν=(N_{μ-T-1}N_{μ-T-2} . . . N_{T}, N_{T-1} . . . N₁N₀)_{ρ}.

Notably, where T>0 (ν>1),N′ is a decimal number (see the commas between N_{T} and N_{T-1}).

Where the least significant digit (LSD) z_{m,0}* of Zₘ* is equal to zero (i.e., z_{m,0}*=0), ρ divides the number Zₘ* (designated with ρ|Zₘ*) as follows:

Zₘ*/ρ=Zₘ′=(z_{m,ξ(m)-1}*z_{m,ξ(m)-2}* . . . z_{m,1}*)_{ρ}∈Z.

That is, Zₘ* is shifted towards the LSD by one digit position in order to obtain Zₘ′ (as an integer). Where z_{m,0}*≠0, then p does not divide Zₘ* (designated with ρΦZₘ*; Zₘ*/ρ∉Z). In this case, Zₘ* is supplemented. The supplementation term eₘ=iₘ·N/ν=iₘ·N′ is usually a decimal number (for T>0 (ν>1)) with a radix specification

eₘ=(e_{m,∈(m)-1}e_{m,∈(m)-2} . . . e_{m,T-1}, e_{m,T} . . . e_{m,1}e_{m,0})_{ρ}; Λρ(eₘ)=∈(m); μ−T<∈(m)<μ−T+1.

The m-th supplementation factor iₘ and the modulus divisor ν=ρ^{T} are selected such that after the supplementation, where

Zₘ′=Zₘ*+iₘ·N/ν=Zₘ*+iₘ·N′=Zₘ*+eₘ=(z_{m,ξ(m)-1}*z_{m,ξ(m)-2}* . . . z_{m,1}*z_{m,0}*)_{ρ}+iₘ·(N_{μ-T-1}N_{μ-T-2} . . . N_{T},N_{T-1} . . . N₁N₀)_{ρ}=(z_{m,φ(m)-1}′z_{m,φ(m)-2}′ . . . z_{m,1}′0)_{ρ}; Λρ(Zₘ′)=φ(m) (28)

at least the LSD in Zₘ′ becomes zero (z_{m,0}′=0). Using this supplementation, ρ divides Zₘ′. Thus, by shifting Zₘ′ one digit position towards the LSD, an integer result

Zₘ′/ρ=(z_{m,φ(m)-1}′z_{m,φ(m)-2}′ . . . z_{m,1}′)_{ρ}

may be obtained. Using this result, the next step of the recursion (25) may be performed.

The following examples, where ρ=10, demonstrate the determination of the supplementation factors where ν=1; (T=0) and where ν=ρ; (T=1).

### Example 1

Let ν=1, N′=N=(31)₁₀; (Λρ(N)=μ=2) and Zₘ*=(358)₁₀; (Λρ(Zₘ*)=ξ(m)=3). Since ρΦZₘ*(10Φ358), the not yet supplemented numerator Zₘ* is supplemented by adding up the supplementation term iₘ·N==iₘ·N′=eₘ. To obtain an integer after the supplementation and dividing by ρ, iₘ should be equal to 2, because 2·31=62 and 62+358=420=Zₘ′, so that Zₘ′/ρ=42.

### Example 2

Let N=(35)₁₀; and Zₘ*=(358)₁₀. In this case the decimal number N′=N/ρ=(3,5)₁₀ (ν=ρ=10) should be used since 0 or 5 are the possible LSDs for ν=1 the supplementation term iₘ·N, and it is impracticable to supplement all possible values of Zₘ*. The non-supplemented numerator Zₘ* is supplemented by adding up the supplementation term iₘ·N′=eₘ since ρΦZₘ* (10Φ358). In order to obtain an integer after dividing by ρ=10, iₘ should be selected as being equal to 12, because 12·3,5=42 and 42+358=400=Zₘ′, so that Zₘ′/ρ=40.

Apart from condition (28) a further condition (30) is fulfilled, in order to be able to utilize the supplemented product continued fraction E_{N}(a·b/ρ^{K}) for the calculation of the modular multiplication. For example, let m₀, m₁, . . . , m_{L} (K−1≧m_{L}>m_{L-1}> . . . >m₁>m₀≧0; K−1≧L≧0) be the indices of those numerators in equation (27) in which the supplementation function (26) Con(iₘ·N/ν) assumes values other than zero, and let im₀, im₁, . . . , im_{L} be the corresponding supplementation factors. The supplemented product continued fraction (27) may then be transcribed as a sum of the original product continued fraction (a·b)/ρ^{K} and the resealed supplementation terms

$$\begin{matrix}{ℰ}_{N} ( a \cdot b / {ρ}^{𝒦} ) = \frac{a \cdot b}{{ρ}^{𝒦}} + \frac{{i}_{{m}_{0}} \cdot N / v}{{ρ}^{𝒦 - {m}_{0}}} + \frac{{i}_{{m}_{1}} \cdot N / v}{{ρ}^{𝒦 - {m}_{1}}} + … + \frac{{i}_{{m}_{L}} \cdot N / v}{{ρ}^{𝒦 - {m}_{L}}} \\ = \frac{a \cdot b}{{ρ}^{𝒦}} + \frac{{ρ}^{{m}_{0}} \cdot {i}_{{m}_{0}} \cdot N + {ρ}^{{m}_{i}} \cdot {i}_{{m}_{1}} \cdot N + … + {ρ}^{{m}_{L}} \cdot {i}_{{m}_{L}} \cdot N}{v \cdot {ρ}^{𝒦}} \\ = \frac{a \cdot b}{{ρ}^{𝒦}} + \frac{{j}^{′} \cdot N}{v \cdot {ρ}^{𝒦}}\end{matrix} \qquad ( 29 )$$

Where the modulus divisor ν divides the formed natural number j′,

ν|j′; j′=ρ^{m0}·im₀+ρ^{m1}·im₁+ . . . +ρ^{mL}·im_{L} (30)

and a natural number j∈N after the division j′/ν=j is obtained, the supplemented product continued fraction (27) or (29) may be presented in the following form:

E_{N}(a·b/ρ^{K})=(a·b+j·N)/ρ^{K}∈N; j∈N (31)

This condition allows the supplemented product continued fraction for the calculation of the modular multiplication to be utilized.

The result of equation (31) (i.e., dividing a·b+j·N∈Z by ρ^{K}, where K≧K) is considerably reduced with respect to the product a·b. In addition, the supplemented product continued fraction E_{N}(a·b/ρ^{K}) includes a relatively small multiple λ of the modulus N. In some embodiments, the multiple X may become smaller than N; i.e. λ=0. Where λ>0, a trivial reduction by λ-fold subtracting the modulus N from the supplemented product continued fraction E_{N}(a·b/ρ^{K}) is sufficient, such that

R_{N}[E_{N}(a·b/ρ^{K})]=E_{N}(a·b/ρ^{K})−λ·N (32)

is true, while λ∈N may exist with a relatively small upper bound Λ∈N (λ≧Λ). This special form of the remainder of the supplemented product continued fraction (32) is termed the continued fraction transformation, provided that j∈N (i.e. (30)) is true. The designation for the continued fraction transformation is as follows:

K_{N,K}[a·b]=R_{N}[E_{N}(a·b/ρ^{K})]=(a·b+j·N)/ρ^{K}−λ·N (33)

The transformation K_{N,K}[a·b] (33) is a function of integers a and b, the radix ρ, the modulus N, the modulus divisor ν and the supplementation factors {iₘ|m=1, . . . , K−1}. The transformation K_{N,K}[a·b] allows the calculation of the modular product R_{N}[a·b] by the additional calculation of the following modular product:

$$\begin{matrix}{R}_{N} [ a \cdot b ] = {R}_{N} [ c \cdot t ] , \\ = {R}_{N} [ {K}_{N , K} [ a \cdot b ] \cdot {ρ}^{K} ] ,\end{matrix} \qquad ( 34 a )$$

or according to the attribute (18b)

=R_{N}[K_{N,K}[a·b]·R_{N}[ρ^{K}]] (34b)

where c=K_{N,K}[a·b] is the continued fraction transformation and t=ρ^{K} is the radix power (or the remainder R_{N}[ρ^{K}]). The relation in equation (34a) can easily be proven by substituting equation (33) into equation (34a).

This direct inverse transformation (34) does not have the same fowl as the continued fraction transformation (33) and is calculated using a different algorithm, which could be disadvantageous for the circuit architecture. However, an identical inverse transformation (similar to the continued fraction transformation, except having different arguments) allows the modular product to be calculated. In this process, the continued fraction transformation K_{N,K}[c·d] is calculated, where c=K_{N,K}[a·b] and t²=ρ^{2K}, such that

K_{N,K}[c·t²]=R_{N}[a·b]=K_{N,K}[K_{N,K}[a·b]·ρ^{2K}] (35A)

is true.

The equation (35A) may be transcribed into an equivalent form as follows:

R_{N}[a·b]=R_{N}[K_{N,K}[a·b]·ρ^{K}]=R_{N}[K_{N,K}[a·b]·ρ^{2K}/ρ^{K}]=R_{N}[c·ρ^{2K}/ρ^{K}] (35B)

Since c and the product fraction c·ρ^{2K}/ρ^{K} are integers, they are automatically supplemented product fractions

c·ρ^{2K}/ρ^{K}=E_{N}(c·ρ^{2K}/ρ^{K})=E_{N}(c·t²/ρ^{K}) (35C)

with j=0 in (31). By substituting equation (35C) into equation (35B), and according to the definition of the continued fraction transformation (33)

R_{N}[a·b]=R_{N}[E_{N}(c·ρ^{2K}/ρ^{K})]=R_{N}[E_{N}(c·t²/ρ^{K})]=K_{N,K}[c·t²] (35D)

the validity of equation (35A) may be easily shown.

Since the continued fraction transformation represents a modular remainder, the following is true according to the equations (18B) and (35D):

R_{N}[a·b]=K_{N,K}[c·R_{N}[t²]] (36A)

or in short form

R_{N}[a·b]=K_{N,K}[c·d]=K_{N,K}[d·c] (36B)

where c=K_{N,K}[a·b] and d=R_{N}[t²]=R_{N}[ρ^{2K}]. The continued fraction transformation (36) is termed continued fraction inverse transformation.

Hence it follows that the transformation pair K_{N,K}[a·b]=c and K_{N,K}[c·d] results in the modular product R_{N}[a·b] with (36B), where the radix exponent K∈N\{0} in the transformation K_{N,K}[a·b]=c and in the inverse transformation K_{N,K}[c·d] has the same value K≧K.

Until now, it has been assumed that K=K, where K is equal to the length of the broken down operand (which is indicated in the weighted form). However, where the broken down operand is longer than K (i.e., K<K) in the continued fraction inverse transformation, the aforesaid assumptions will no longer be true. According to the previously used notation, for example, (saying that the first operand in the product is always indicated in weighted form), the commutativity does not apply in (35A); i.e. K_{N,K}[ρ^{2K}·K_{N,K}[a·b]] will usually not yield R_{N}[a·b] (because Λρ(ρ^{2K})=K=2K>K).

To avoid this impractical dependence of operand lengths, it is possible to prescribe a sufficiently large value K=K for the radix exponent K, such that

K≧Λρ(z) (37)

is true, where Λρ(z) is the length of the longer broken down operand z in a transformation pair K_{N,K}[a·b]=c and K_{N,K}[c·d] (z is the longer one between a and c). Where Λρ(z) is smaller than K, the broken down operands are supplemented behind their most significant digit (MSD) with zeros up to the K-th digit place. Thus, a supplemented product continued fraction (29) is performed in, for example, exactly K recursion steps.

Where the length of the unbroken operand in a supplemented product continued fraction is larger than the length of the modulus Λρ(N), the bound A for k in equation (32) may become too large and thus overcomplicating the before trivial reduction. This may happen in equation (35A). Similarly, the reduction in equation (36A) may become over complicated due to the attribute (2). Therefore, for practical applications, the continued fraction inverse transformation (36A) is used.

However, where the constraints a, b<N are valid and ν=1, the value Λ=1 for the bound for in equation (32) can be guaranteed. The value (Λ) 1 indicates that the modulus N may be subtracted from the supplemented product continued fraction in equation (32), e.g., once at the most, in order to obtain its remainder for N.

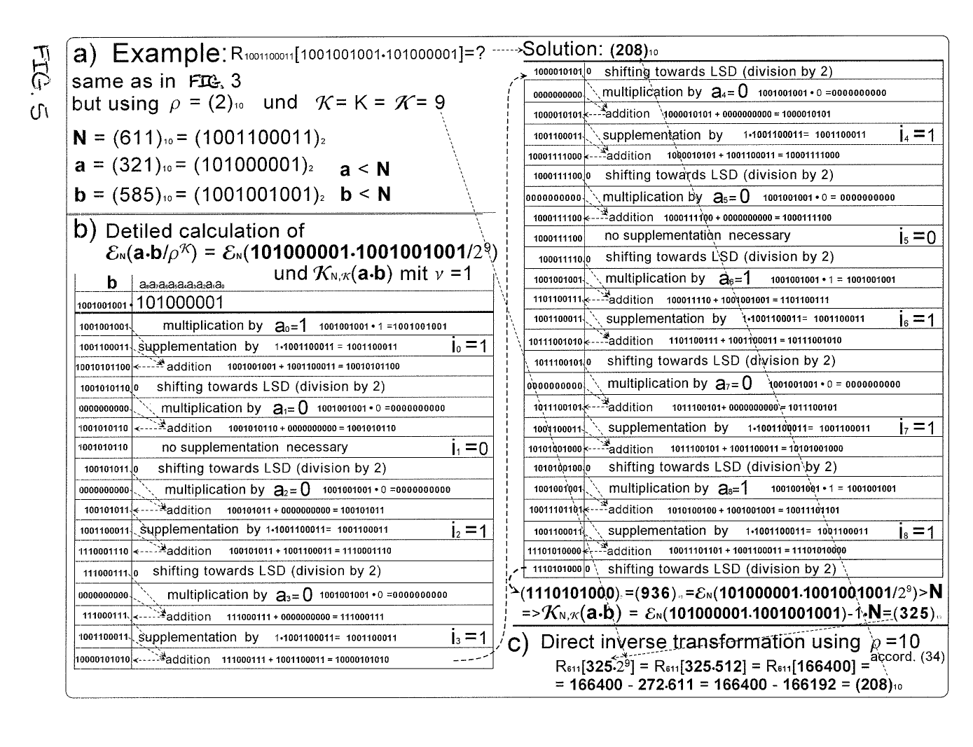

The selection of the modulus divisor ν and the calculation of the supplementation factors {iₘ|m=1, . . . K−1} depend on the modulus N and the radix p. The calculations using combinations p and N may be simple for some parameters and more complex or even practically impossible for other parameters. For example, a calculation using ρ=2 and N is odd is very simple. Then iₘ∈{0, 1} with ν=1. A supplementation factor iₘ equals 1, where, in the previous recursion step, there is an odd number (e.g., see FIG. 5). This binary case covers most moduli as they are used in the asymmetric cryptography—i.e., the odd moduli.

The aforesaid method may also be used to calculate the modular product for some even moduli where ρ=2. For example, this is true where an even modulus in the binary representation ends with only one zero (i.e. N₀=0 and the last but one weight 2¹ is multiplied with N₁=1). Here ν=ρ=2 is selected and the calculation of the supplementation factors is the same as when N is odd, where the operands a or b (or both) are even. However, where a and b are odd, it can easily be determined from the conditions (29) and (30) that supplementation according to equation (31) is practically impossible. In these cases, the operand a may be replaced by a′=a+1 (a′ will then be even, hence R_{N}[a′·b] can be calculated in a simple manner). A subsequent correction R_{N}[a′·b]−b and, if required, the consideration of the attribute (3), also yields the result R_{N}[a·b] in this case in a relatively simple manner.

Where an even modulus for ρ=2 ends with J>1 successive zeros, ν=ρ^{J}=2^{J} is selected to determine the supplementation factors. Using conditions (29) and (30), supplementation of the continued fraction a·b/ρ^{K} with supplementation factors may be easily shown possible where the broken down operand a ends with J successive zeros. In the remaining cases, a may be replaced by the nearest such number a′ and a subsequent correction may be performed. However, such a replacement and correction would not be as simple as in the preceding case.

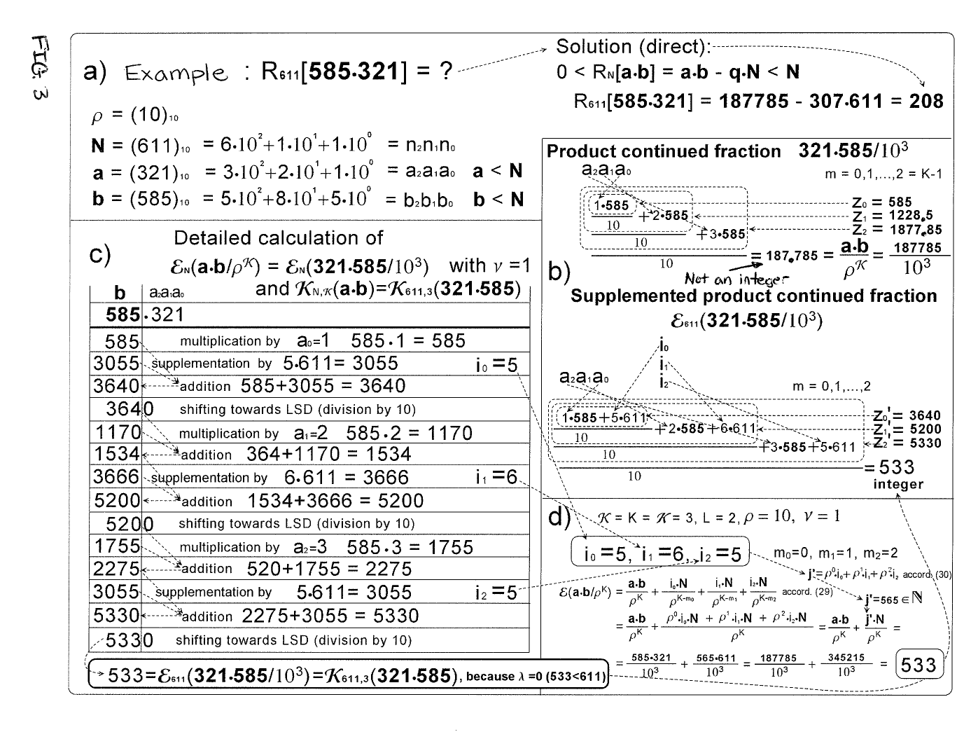

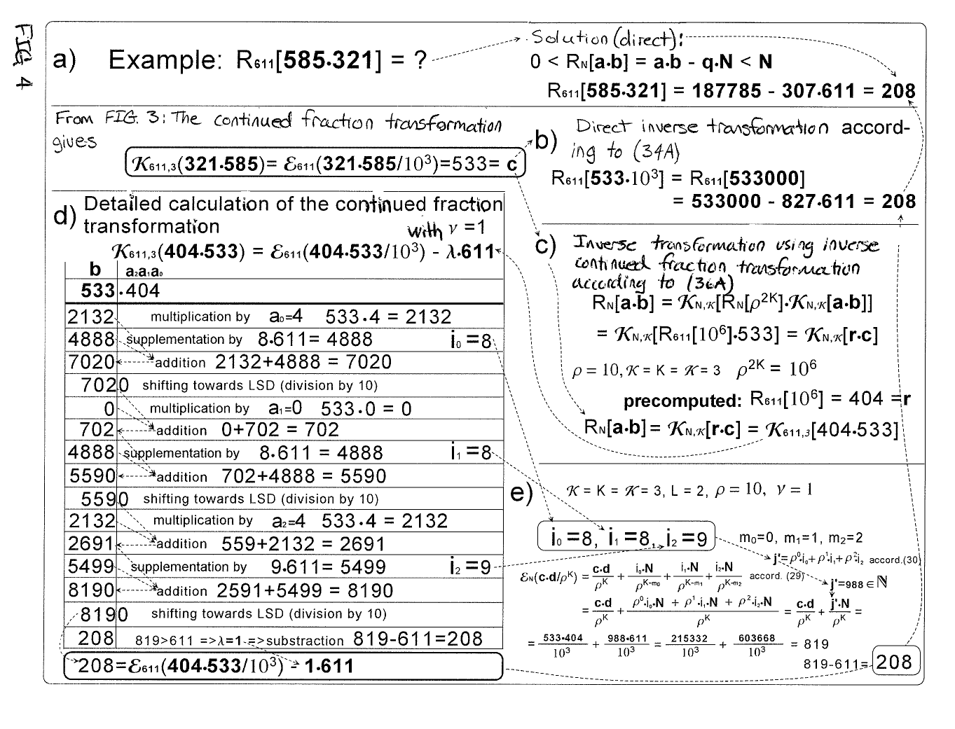

The selection of the modulus divisor ν and the calculation of the supplementation factors {iₘ|m=1, . . . , K−1} for non-binary radix values ρ>2 is very simple where N is odd and its LSD N₀ does not divide radix ρ. Here, the supplementation factors are determined as iₘ·N with ν=1 as shown in FIGS. 3 and 4. Where N is odd and its LSD N₀ divides radix ρ, or where N is even and N₀ is not equal to zero, the supplementations are determined as iₘ·N/ρ with ν=ρ, (see Example 2). Notably, the required condition (30) need not always be fulfilled. For these cases, and in particular where N ends with J>0 successive zeros, the calculation of the suitable supplementation factors may become complex and necessitate solutions with subsequent corrections.

FIG. 3 illustrates a first embodiment of the aforesaid method. Here, the modular multiplication of the numbers a=321 and b=585 with respect to the modulus N=611 is calculated, while a representation with respect to radix ρ=10 is selected.

FIG. 3A shows the segmentation of the occurring numbers into the digits which appear with this radix. In this example, the direct calculation of the solution is possible using minimal effort: It is known that the following must be true:

0≦R₆₁₁[321·585]=321·585−q·611<611,

where the associated quotient q is to be determined. The calculation (321·585)/611 yields 307,34 . . . , hence q=307 and the sought-after remainder is given by 321·585−307·611=208. This is the value that has to be reproduced by use of the method according to the invention.

First, the product continued fraction is determined as in FIG. 2B to verify whether it is an integer in the concrete case. The operand a includes the digits a₂=3, a₁=2 and a₀=1, so that the free variable m goes through the values 0, 1 and 2 and the value 3 will arise for K=K. Accordingly, the numerator Z₀ is given by 1·585, the numerator Z₁ is given by Z₀/10+2·585=58.5+1170=1228.5 and the numerator Z₂ is given by Z₁/10+3·585=122.85+1755=1877.85. The entire continued fraction is represented by Z₂/10=187.785, which obviously is not an integer but represents the value a·b/ρ^{K}.

The supplemented product continued fraction is formed as modular arithmetic is not defined for true rational numbers. Thus, the integer b (e.g., 585) is multiplied with the respective digits of the integer a. For each multiplication, the result is supplemented, where necessary, with a multiple of the modulus in such a manner that the supplemented numerator is divisible by the radix, with the respectively supplemented numerator after shifting towards the LSD being incorporated in the following calculation as addend. For example in FIG. 3C, the following is true: For the digit a₀=1,585 is multiplied by 1. For the result 585 to yield a number which is divisible by 10, the product i₀·N=i₀·611 should end on 5. The smallest number i₀ which fulfills this condition is S. Thus, 5·611=3055 is supplemented to 585 and i₀ may be found. As the supplemented LSD numerator Z₀′ amounts to 3055+585=3640, the addend equals 364 after shifting towards the LSD.

The multiplication of 585 with the digit a₁=2 yields the number 1170 to which the addend 364 is added, resulting in 1534. This number, 1534, is supplemented with a multiple i₁ of N such that the result is divisible by the radix 10. Hence, i₁·611 should end on 6, which is first fulfilled when i₁=6. Thus 6·611=3666 is supplemented, the first supplemented numerator is Z₁′=1534+3666=5200, and the addend, after shifting towards the LSD (through division by 10), is equal to 520.

The third digit may be calculated in a similar manner: multiplication with a₂=3 renders 585·3=1755; after addition of the addend 520 one obtains 1755+520=2275; the multiple of 611 which is to be supplemented must end on 5, which is first fulfilled for i₂=5, so that 3055 is to be supplemented; 2275+3055 yields 5330 and after division by ρ=10 the supplemented product continued fraction E_{N}(a·b/ρ^{K})=E₆₁₁(321·585/10³)=533 is obtained. Where a number is obtained which is larger than the modulus, the modulus is subtracted from the result until the result is smaller than the modulus. Since 533<611, the continued fraction transformation is K_{N,K}[a·b]=K_{611,3} [321·585]=533.

As shown in FIG. 3D, the result of the method shown in FIGS. 3A-3C is that the supplemented product continued fraction is an integer, where j′=565 in the resealed supplementation term from condition (29).

However, only the first step for determining the result of the modular multiplication has been carried out. Further steps to be performed for the solution of the modular multiplication, i.e. the necessary inverse transformation, starting from the results of the transformation, are depicted in FIG. 4. Referring to FIG. 4A, the result of the direct calculation is reproduced to explain the comparison with the solutions according to the method of the invention.

FIG. 4b illustrates the direct inverse transformation (34). The correct result is directly obtained where the modular multiplication between the afore obtained result K_{611,3} [321·585]=533 and the radix power ρ^{K}=10³ is performed. However, this calculation does not have the same form as the continued fraction transformation (33) and would have to be calculated with another algorithm.

Instead of using an alternate algorithm, the inverse transformation is performed using a second continued fraction transformation (36), as shown in FIG. 4C. Advantageously, the same hardware implementation may be used.

Similar to the method in FIG. 3, there may be at least one modular reduction of a relatively large number, e.g. d=R_{N}[ρ^{2K}]=R₆₁₁[10⁶]=404, which may be performed. The calculation of the modular reduction may be performed according to the steps shown in FIG. 4D, which are substantially the same as shown in FIG. 3C. Briefly, the operand d=R₆₁₁[10⁶]=404 is broken down in its digits d₂=4, d₁=0, d₀=4. Starting with digit d₀, the following operations are performed: multiplication with the digit, addition of the addend, supplementation with the smallest multiple of the modulus, if applicable, resulting in a number divisible by the radix, and shifting towards the LSD. Notably, a result, e.g. E₆₁₁(404·533/10³)=819, may be obtained that is larger than the modulus value, e.g. 611. In this circumstance, the modulus value is subtracted once from the result (e.g., 819−611=208).

FIG. 4E shows that the supplemented product continued fraction results in an integer j=j′=988 (for ν=1) in the resealed supplementation term from equation (29).

FIG. 5 shows the analog calculation for the modular product with respect to the radix ρ=2. This selection is of particular interest, as will be explained in detail below, because significant simplifications of the circuit architecture are achieved within the hardware implementation. These implications are based in particular on the possibility of division by the radix using bit shifting and the straightforward determination of the supplementation terms as well as a standardized calculation for all modulus values.

FIG. 5A shows the diagrams of the operands in a segmentation related to the radix ρ=2. In FIG. 5B shows that the individual steps in the calculation of the supplemented product continued fraction may be reproduced. In particular, the modulus is, e.g., always supplemented where the last bit of the non-supplemented numerator is 1.

It should be noted that the continued fraction transformation of the same product may yield a different result in a representation for another radix. However, the corresponding inverse transformation, presented on the direct way for ρ=10 in FIG. 5C, produces the correct final result.

The presented technique for the calculation of the modular multiplication with continued fraction transformation (33) may also be applied for calculations using polynomials, by replacing the radix power ρ^{K} with x^{K} and additionally noting that carries are not taken into consideration in the polynomial addition (!) and subtraction (∀). Thus, the multiple k is equal to zero when considering condition (40) and attribute (20a). According to this condition, a subsequent trivial reduction by λ-fold subtracting modulus N(x) is superfluous for the continued fraction transformation with polynomials. According to transformation (33), the continued fraction transformation for two polynomials a(x), b(x)∈Z_{N}[x]_{N(x)} is as follows:

$$\begin{matrix}{K}_{N ( x )} [ a ( x ) b ( x ) ] = {R}_{N ( x )} [ {E}_{N ( x )} ( a ( x ) b ( x ) / {x}^{K} ) ] \\ = ( a ( x ) b ( x ) ! j ( x ) N ( x ) ) / {x}^{K} .\end{matrix} \qquad ( 38 )$$

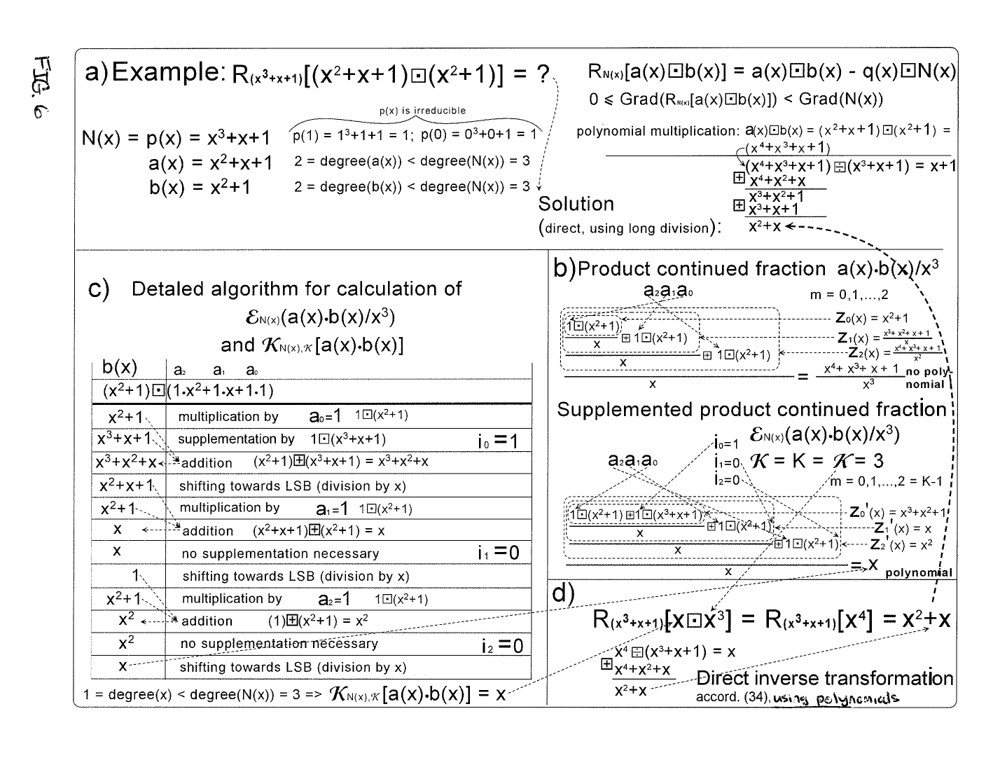

FIG. 6 illustrates one example of a method for the modular multiplication with continued fraction transformation on polynomials from Z₂[x]_{N(x)}. For example, the modular product of the polynomials a(x)=x²+x+1 and b(x)=x²+1 is calculated for the irreducible modulus polynomial N(x)=p(x)=x³+x+1.

Referring to FIG. 6A, the direct solution R_{N(x)}[a(x) [symbol] b(x)]=x²+x is obtained using polynomial division (with the remainder). Notably, the calculation with the coefficients of the powers of x is performed binarily and carry-free for addition and multiplication, which is suggested by special addition and multiplication signs (! and [symbol] , respectively). While the “conventional” calculation (over the ring of integers Z_{N}[x]) of the product of the two polynomials (x²+x+1)·(x²+1) results in x⁴+X³+2x²+x+1, the calculation with binary coefficients (over the ring Z₂[x]) yields the result x⁴+x³+x+1.

As set forth above, the method begins by determining the individual digits of the operands, where the “radix” is x. The digits a₂=1, a₁=1, a₀=1 arise for a(x).

The formation of the associated product continued fraction (according to equation (24) as applied to polynomials) is shown in the top half of FIG. 6B. The first numerator Z₀(x) is calculated by binarily multiplying b(x) with digit a₀. For calculating the next respective numerator, the last obtained numerator is divided by the “radix” x and binarily added to the product of b(x) with the respectively current digit, where the arithmetic operations is performed in a carry-free manner. The final result of this procedure is (x⁴+x³+x+1)/x³, i.e. no polynomial, such that the supplemented product continued fraction is calculated according to equation (27), as illustrated in the lower half of FIG. 6B. FIG. 6C shows a method of long division. FIG. 6D shows the direct inverse transformation, which verifies the solution given in FIG. 6A.

Apart from the modular multiplication (as described above), full modular arithmetic includes modular addition, modular subtraction and inversion (or division) in finite fields. As mentioned above, the realization of modular addition and subtraction is simple where the operands have the same order as the modulus. If this assumption is further intensified by presupposing that the two operands are smaller than the modulus (in symbols a, b<N), it is sufficient to subtract the modulus, e.g., only once during modular addition and subtraction in order to obtain the modular result.

The respective assumption for the calculation with polynomials relates to the polynomial degrees such that the degrees of the two operand polynomials are smaller than the degree of the modulus polynomial (in symbols degree(a(x)), degree(b(x))<degree(N(x))). For the arithmetic in finite fields and rings Zₘ of integers modulo M these assumptions are, e.g., always fulfilled because the individual elements or their degree are all smaller than the respective modulus or its degree. For this reason, this document uses the following conditions:

a,b<N, and (39)

degree(a(x)), degree(b(x))<degree(N(x)) (40)

The modular division in finite fields is traceable to the modular inversion by performing a modular multiplication with the modular inverse of the divisor. The modular inversion is an operation that, for a given number a, finds an inverse number a⁻¹, where R_{N}[a·a⁻¹]=1 is true. In Z this equation has no general solution, but can be solved for certain combinations of N and a. In finite fields Φₚ and Φₚm, however, it has a solution.

Fermat's little theorem provides one way to determine a⁻¹ (or a(x)⁻¹ for polynomials). According to the theorem, the (N−2)nd power of each element of a finite field is the modular inverse of exactly that element. Using this procedure, the modular inversion and hence the modular division may be reduced to the multiple execution of the modular multiplication. Alternatively, methods may be used which are based on the Extended Euclidean Algorithm.

The square-and-multiply technique is frequently used for modular exponentiation with a natural number. Alternatively, variations of the square-and-multiply technique based on addition chains may be used. One example of such a variation is disclosed in the article “The Art of Computer Programming” by Donald Knuth (Volume 2: Seminumerical Algorithms, Addison-Welsey, Reading, Mass., Sections 4.3.2 and 4.3.3, pgs 268-303, 1981), which is herein incorporated by reference in its entirety.

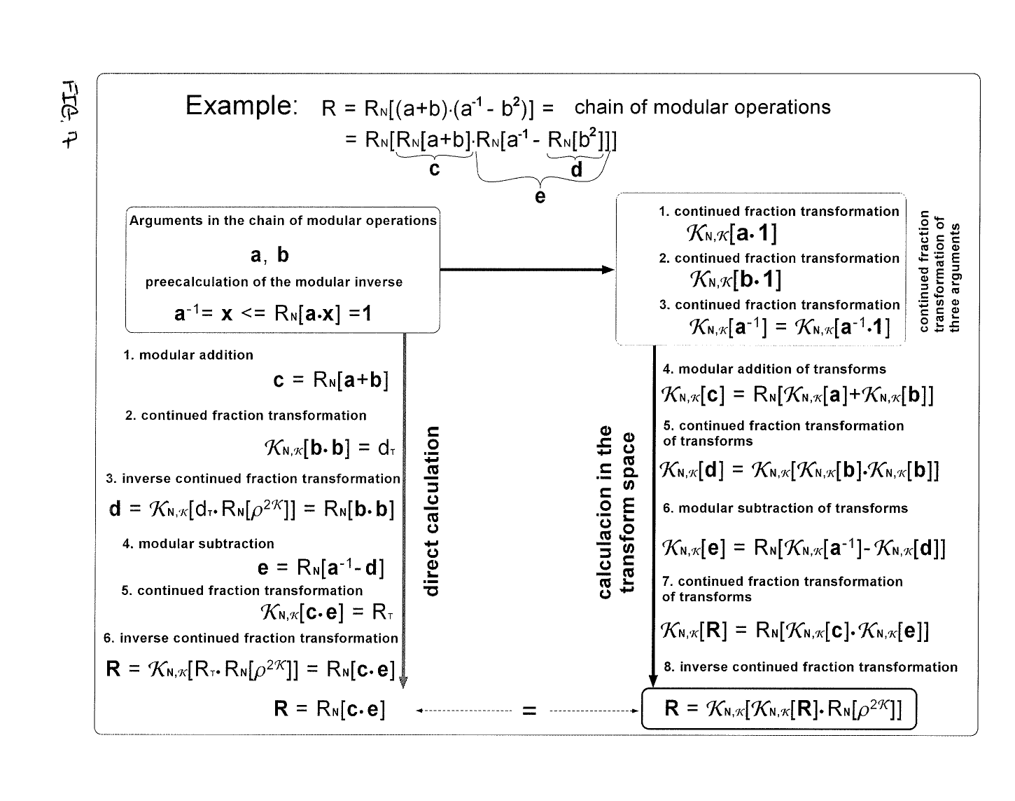

The five basic modular arithmetic operations for integers and for polynomials over Z_{N}[x]_{N(x)} have been introduced above. The modular multiplication has been presented through continued fraction transformation, which uses a final continued fraction inverse transformation. In principle, however, and as shown in FIG. 7, there are two different procedures for transferring the method for performing a modular operation to plural consecutive modular basic operations. The modular multiplication method using the continued fraction transformation employ a final continued fraction inverse transformation. In contrast, where plural modular arithmetic operations are performed in succession, the direct procedure shown on the left side of FIG. 7 is used to individually perform transformations and inverse transformations for each step of calculation.

This procedure uses chains of several basic modular operations (i.e., modular operation chains) in a succession as shown on the right side of FIG. 7. Notably, this succession may have lower computing demands. Instead of performing a continued fraction inverse transformation after each individual continued fraction transformation of a modular product in the operation chain, the inverse transformation is performed at the end of the calculations for the entire operation chain. By performing the inverse transformation at the end of the calculations, all the various operands existing in the operation chain are transformed with a continued fraction transformation at the beginning of the calculations. This is done by considering the involved operands “O” as products with an identity operator (O=O·1) and by subsequent continued fraction transformation of this formal product. Subsequently, all basic modular operations existing in the operation chain are performed with the transformed entities. The results from the basic modular operations are thereafter converted into final results with a single continued fraction inverse transformation.

This procedure is particularly advantageous when applied to long operation chains that have a relatively large number of modular multiplications and a relatively small number of initial operands; e.g., modular exponentiation with a natural number. However, where the procedure is applied to operation chains that have a relatively small number of modular multiplications and a relatively large number of initial operands, the additional efforts to transition into the space of the transformed entity may outweigh the advantages associated therewith.

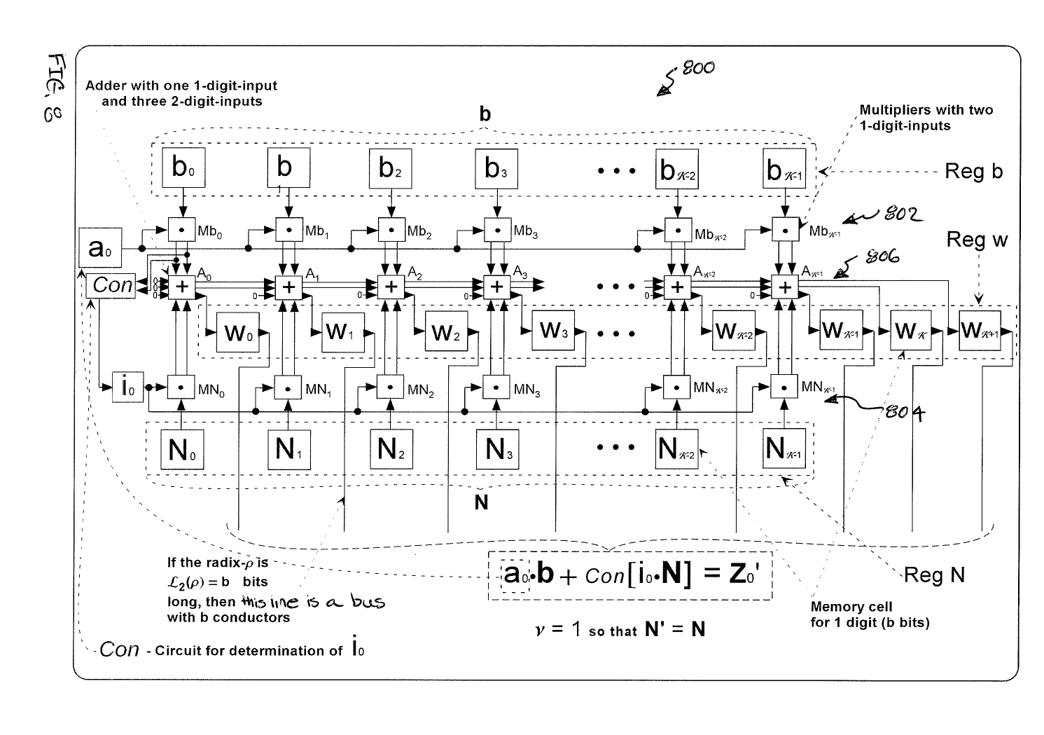

FIG. 8 illustrates one embodiment of a digital circuit 800 for implementing the method described above. In the circuit 800, the implementation of the continued fraction transformation according to equations (33) and (38) is reduced to the implementation of the supplemented product continued fraction E_{N}(a·b/ρ^{K}) for integers a and b, modulus N and radix p according to equation (27) (see FIG. 2C). Similarly, the implementation for polynomials occurs in accordance with the same principle and is therefore not treated separately below.

For simplicity, the assumption ν=1 (N′=N) will be applied to the circuits described below, since in cases where ν>1; ν=ρ^{T}∈N\{0}; T∈N, the calculations merely differ by a corresponding shifting of the modulus N by T digits toward the LSD. Moreover, the following constraints shall be applied hereinafter: a, b<N, Λρ(N)=μ, μ≦K, so that K, I≦K, with K=Λρ(a) and I=Λρ(b). The radix representations of the arguments are uniformly specified with a maximal length of K digits:

N=(N_{K-1}N_{K-2} . . . N₁N₀)_{ρ}; a=(a_{K-1}a_{K-2} . . . a₁a₀)_{ρ}; b=(b_{K-1}b_{K-2} . . . b₁b₀)_{ρ},

where, assuming the value zero, the digits Nₖ for K>k>μ in N, the digits aₖ for K>k>K in a, and the digits bₖ for K>k>I in b.

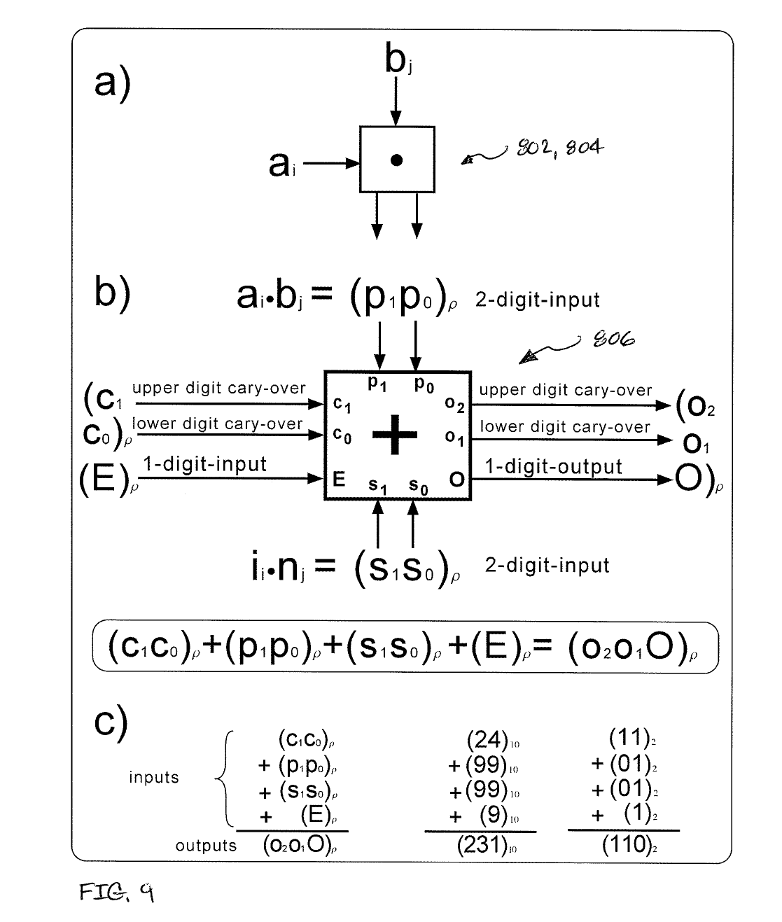

The first numerator Z₀′=a₀·b+Con[i₀·N] of the supplemented product continued fraction is calculated according to equation (27) in FIG. 2C on the direct way by the circuit 800 in FIG. 8. The circuit 800 includes three registers: a register Reg b, a register Reg N and a working register Reg w. The registers Reg b and Reg N are each connected respectively to one series of multipliers 802, 804 (i.e., Mb₀ to Mb_{K-1}, MN₀ to MN_{K-1}) with two 1-digit inputs aᵢ and bᵢ (see FIG. 9A). The outputs of the multipliers 802, 804 in turn are connected to a chain of adders 806 (i.e., A₀ to A_{K-1}). The outputs O of the adders 806 are connected with the working register Reg w. Z₀′ is stored in the working register Reg w as an intermediate result of the calculation of the supplemented product continued fraction. FIG. 9B illustrates one embodiment the adders 806 in FIG. 8. FIG. 9c shows a digit structure of the addition in the adder in FIG. 9B for greatest possible input values with two examples (for ρ=10 and ρ=2). From the postulations a<N and b<N it follows that the first register Reg b is at most as long as the second register Reg N. FIG. 9C shows that the length of the working register Reg w is larger than the length K of the second register Reg N, e.g. by at most two digits, such that the two carries from the most significant adder of the chain can be accepted. Referring again to FIG. 8, the supplementation circuit Con for the supplementation function (26) (see FIG. 2B) determines the supplementation factor i₀, which is dependent on ρ and N. It should be noted that the inputs E (see FIG. 9B) of the adders 806 are not used in this circuit 800 (logical zeros are connected), since Z₀′ is the first numerator of the supplemented product continued fraction and has no predecessors. Rather, the inputs E of the adders 806 are used in the next stage.

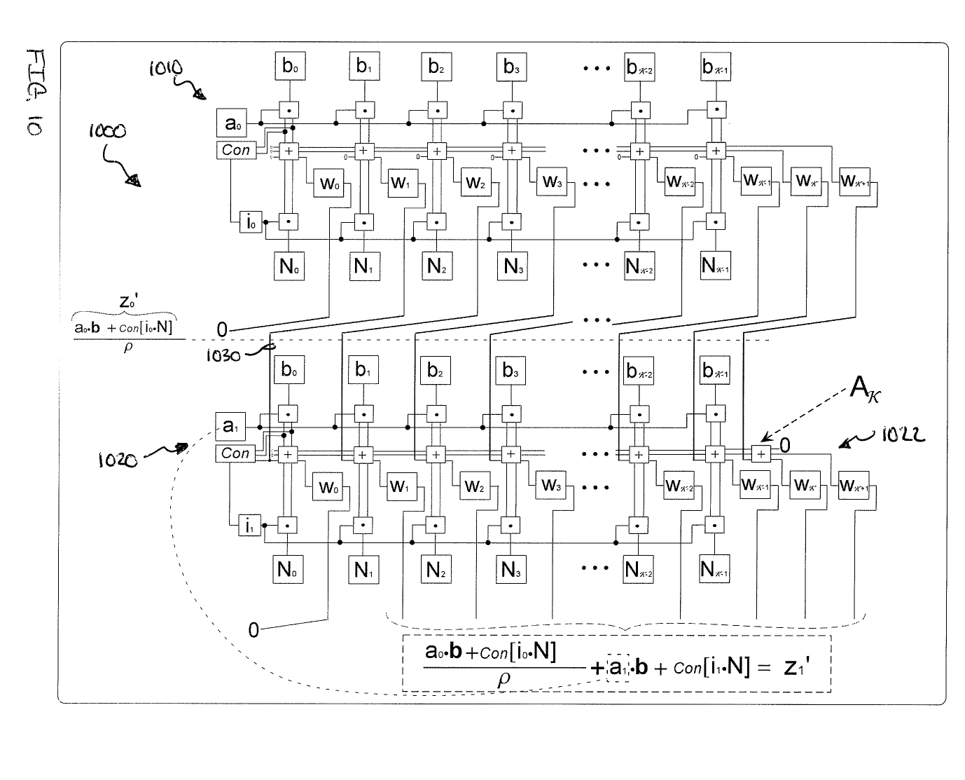

FIG. 10 illustrates one embodiment of a circuit 1000 for calculating the next numerator Z₁′ of the supplemented product continued fraction (27) (see FIG. 2C). The circuit 1000 includes a first circuit block 1010 (“first block”) connected in parallel to a second circuit block 1020 (“second block”). The first and the second blocks 1010, 1020 are configured similarly to the circuit 800 in FIG. 8. The outputs of the work register Reg w in the first block 1010 are connected with the inputs E (see FIG. 9B) of a chain of adders 1022 in the second block 1020. This connection is shifted by one position towards the LSD, whereby a division by ρ is realized. The supplementation circuit Con of the first block 1010 is compelled by the supplementation factor i₀ such that the output (which has remained free by the shifted connection) of w₀ in Reg w of the first block, e.g., always delivers 0. The supplementation circuit Con of the second block 1020 generates the supplementation factor i₁ which according to equation (28) depends on the result of the product a₁·b₀ and z_{0,1}*. z_{0,1}* is stored in work register w₁ of the first block 1010, which has an output connected via line 1030 with the input of the supplementation circuit Con of the second block 1020. As in the first block 1010, the supplementation circuit Con of the second block 1020 is compelled by the supplementation factor i₁ such that the output of w₀ in Reg w of the second block 1020, e.g., always delivers 0. In order to add the shifted (e.g., divided by p) most significant digit from w_{K+1} of the first block 1010 to the position K in the second block 1020, the second block 1020 further includes an additional adder A_{K}. In FIG. 10, the shifting by one position towards the LSD corresponds to a shifting by one position to the left. As set forth above, the registers Reg b and Reg N in FIG. 10 can be seen in double presentation, although only one of them is needed in each case.

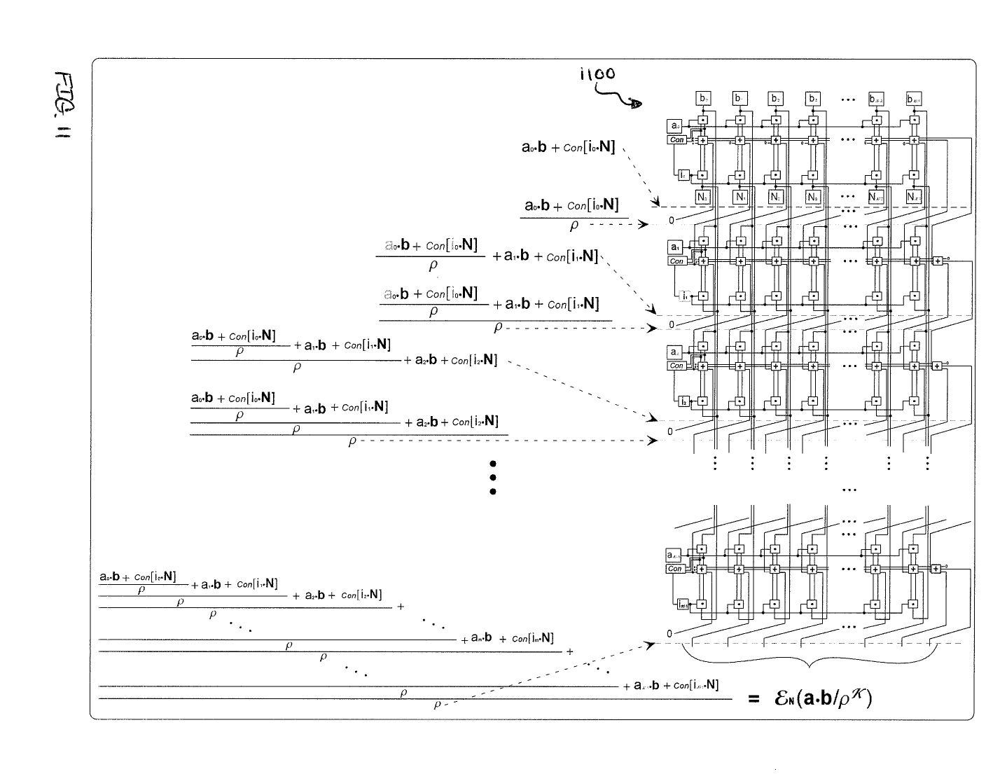

The aforesaid procedure for calculating the numerator Z₁′ can be further extended (see circuit 1100 in FIG. 11) for calculating successive numerators of the supplemented product continued fraction (27). It should be noted that in alternate embodiments, the working register Reg w may be omitted in one or more (e.g., all) of the blocks, because the intermediate results Zₘ′ are passed on (i.e., without storing), e.g. directly, to the next block. In doing so, one achieves a purely combinatorial parallel circuit for the calculation of the supplemented product continued fraction and thus also for the calculation of the continued fraction transformation according to equations (33) and (38). However, the realization of the calculation of the remainder is still missing, which according to equation (32) takes place in the form of a λ-fold subtraction of modulus N. The implementation of this subtraction will be described in detail below (in the context of the explanation of the implementation of modular addition and subtraction).

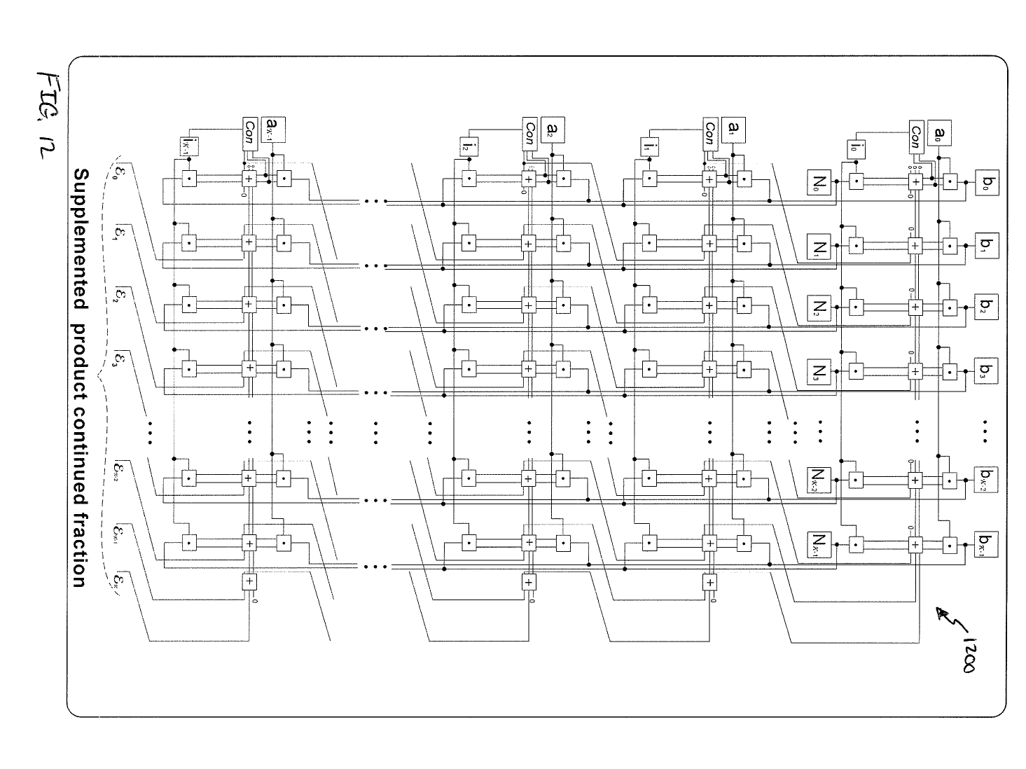

FIG. 12 illustrates one embodiment of a general parallel version of a circuit 1200 for the calculation of the supplemented product continued fraction. While this purely combinatorial circuit may have an increased computational speed, the number of components included therein (e.g., for an appropriate length of N) may be too large for many applications.

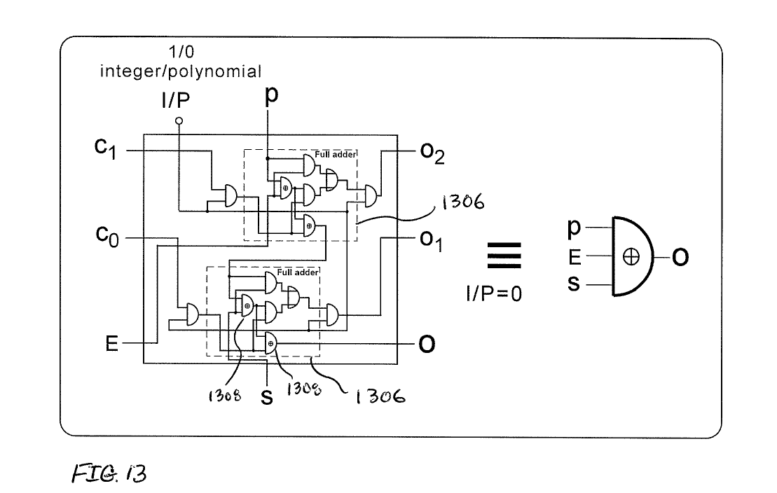

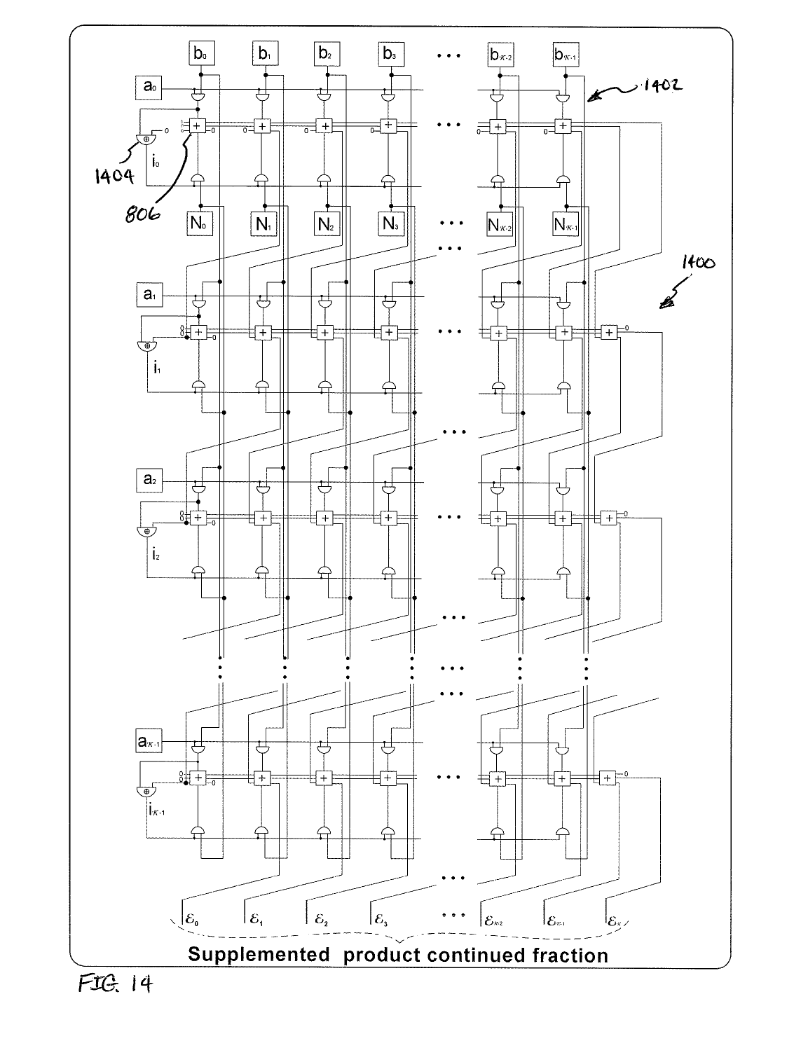

Referring to FIGS. 13 and 14, the parallel circuit 1200 in FIG. 12 may be realized for the binary case; i.e. if the radix ρ=2 is used. Referring to FIG. 14, the general digit multipliers 802 in FIG. 9 include AND gates 1402 and the supplementation function Con includes an XOR gate 1404 where the modulus N is odd (e.g., see FIG. 5). Referring to FIG. 13, adders 806 include or consist of two chained full adders 1306. Such a binary parallel circuit 1400 for the calculation of the supplemented product continued fraction with odd modulus is presented in FIG. 14.

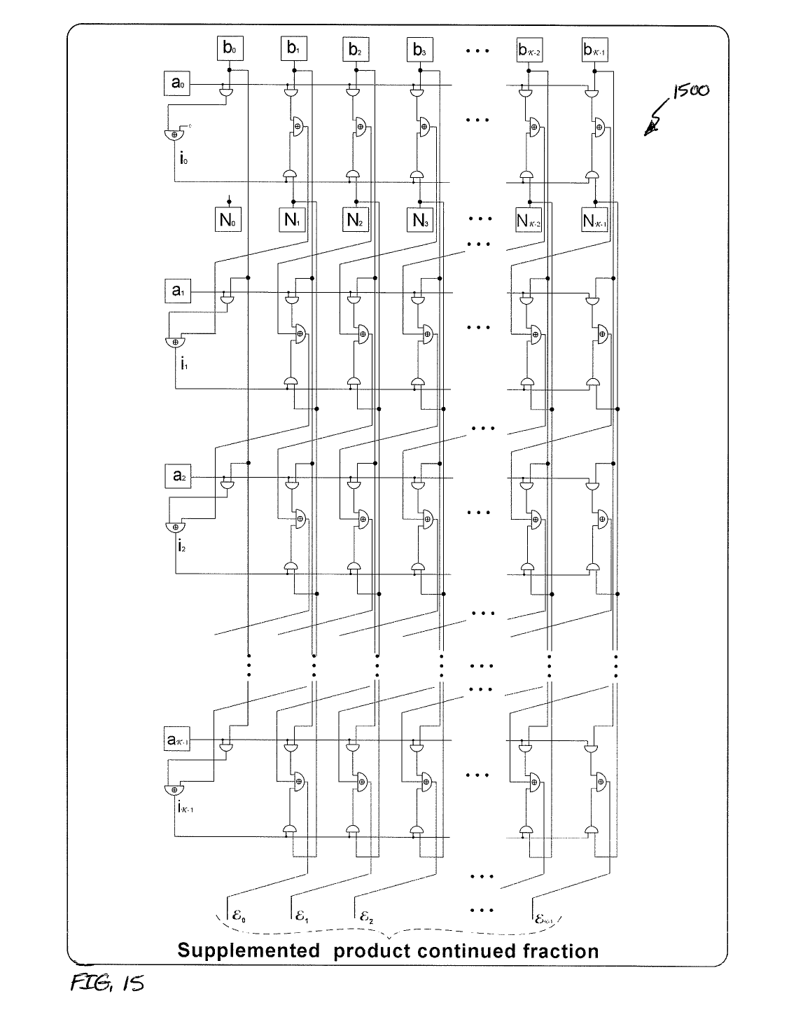

In the course of executing the modular addition with binary polynomials over Z₂[x]_{N(x)}, the calculation occurs component by component and without carries. For these calculations, the adders 1306 include XOR gates 1308 (see FIG. 13). Where the calculations of the supplemented product continued fraction are exclusively for the binary polynomials over Z₂[x]_{N(x)} with odd modulus (i.e., with a modulus N(x) for which the free coefficient N₀ is not equal to zero), a parallel circuit 1500 has an even simpler architecture as illustrated in FIG. 15.

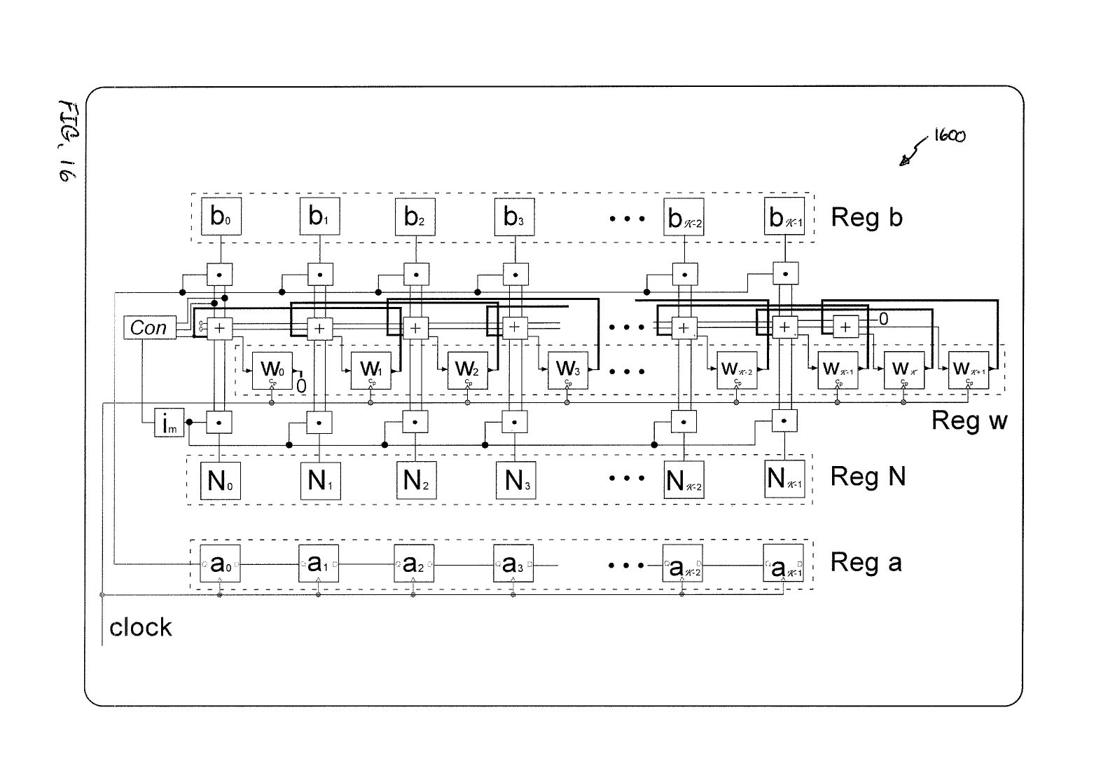

A version with a substantially lower demand of components is achieved where the parallel blocks in FIG. 11 are replaced by a structure with feed-back outputs of the working registers Reg w; that is, one block is used several times. The digits of the operand a have to be imported into the circuit one by one in a clock-controlled manner. The straightforward feedback rule directly follows from the previously described parallel circuit 1500 and is embodied in circuit 1600 in FIG. 16. This circuit 1600 is termed a general serial-parallel circuit for the calculation of the supplemented product continued fraction.

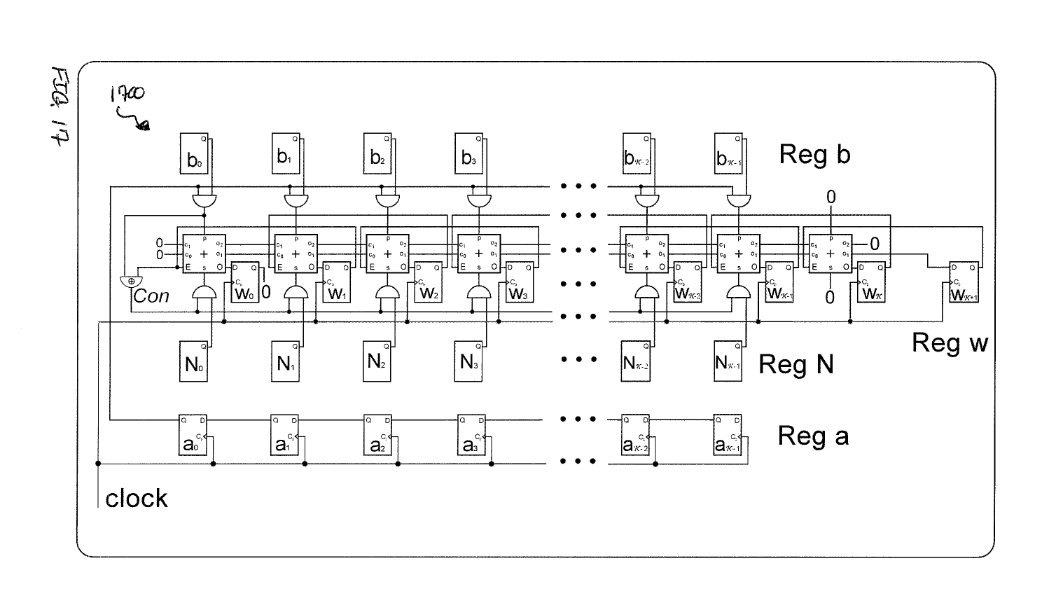

Referring to FIG. 17, a feed-back circuit 1700 may be realized in a particularly favorable manner for the binary case, i.e. where the radix ρ=2 is used. Here, the digit multipliers are AND gates and the supplementation function Con includes an XOR gate where modulus N is odd. The individual memory elements of the registers become D-flipflops and the adders 806 include or consist of two chained full adders 1306 (see FIG. 13). Due to these structural attributes, this binary serial-parallel circuit for the calculation of the supplemented product continued fraction with odd modulus may be easily realized.

In the further progress of this document only the binary case (ρ=2) and N odd will be regarded. For ρ=2 where N is even and for other radix values, the supplementation function (26), which depends on modulus N and radix ρ, is determined at the outset. As already described above, the determination of this function can be very simple (such as for the binary case where N is odd). For other parameter combinations ρ and N, this function may become complex or even practically impossible. In case the determination of the supplementation function (26) can be managed and hence the supplementation circuit Con is specified, the further structure of the circuit for the cases ρ=2 where N is even as well as ρ≠2 is identical with the following special case (for ρ=2 where N is odd). Thus, for simplicity, the binary case (ρ=2) where N is odd will be applied to the following circuits.

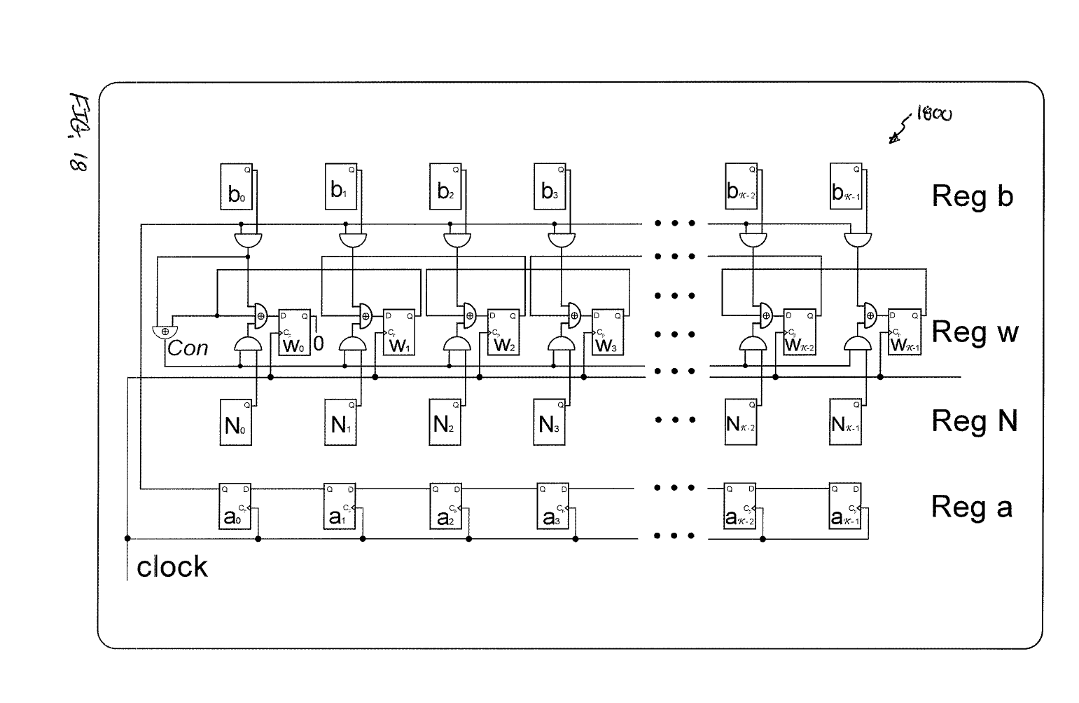

In the circuit 1700 in FIG. 17, the maximal clock rate of the circuit for carrying out the modular arithmetic with integers is strongly limited by the occurring distribution of carries between the individual adders. Where the operand length is sufficiently large, low clock rates are possible. When executing the modular multiplication with binary polynomials over Z₂[x]_{N(x)}, low clock speeds are immaterial because in this case a consideration of carries is not necessary: i.e., the calculation occurs, as mentioned above, in components and without carries. For these calculations, the adders can be switched over by the control input G/P (see FIG. 13). Where the calculations of the supplemented product continued fraction for the binary polynomials over Z₂[x]_{N(x)} with odd a modulus (i.e., a modulus N(x) for which the free coefficient N₀ is not equal to zero), a binary serial-parallel circuit 1800 has a much simpler architecture, as seen in FIG. 18.

However, due to the universality of the binary serial-parallel circuit 1800 in FIG. 18, the carries may have to be taken into consideration. For example in the circuit 1700 in FIG. 17, a multiplication of the operand b with the current bit aₜ of the operand a and a simultaneous supplementation with the corresponding supplementation factor iₜ is performed in each clock period. In order to obtain a correct result, one must wait until the carries have traveled through all K+1 adders. This spreading of the carries through a long chain of adders may severely limit the clock rate.

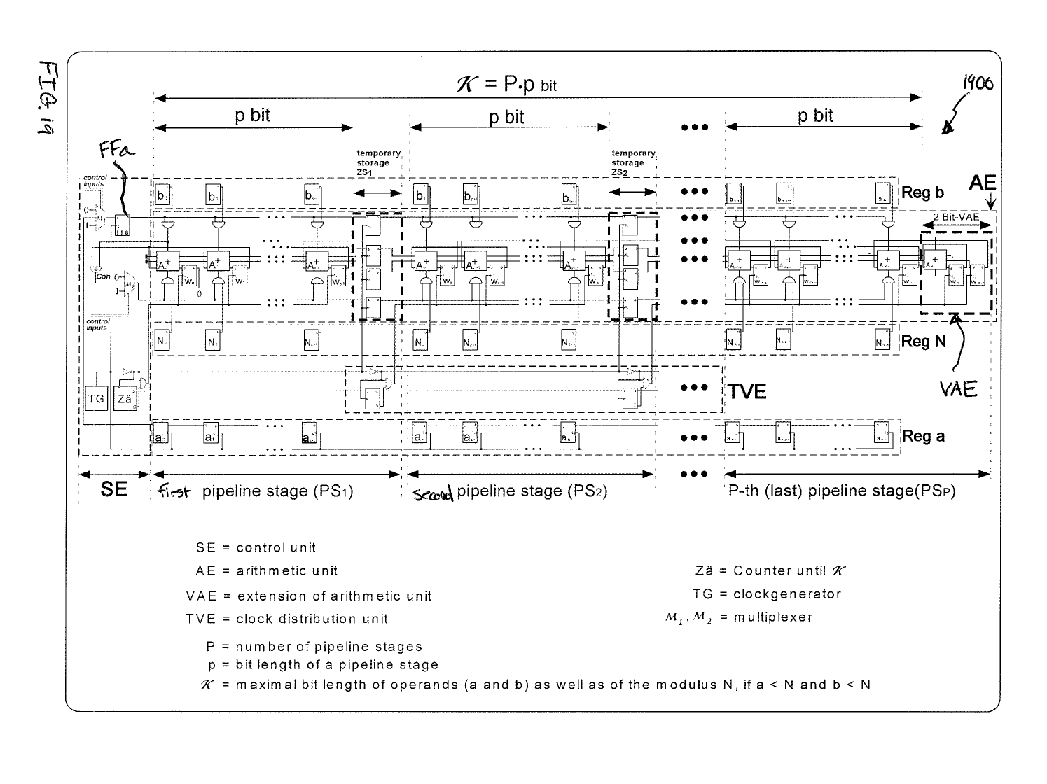

In order to counteract the problem of the limited clock rates when considering carries (i.e., for modular multiplication with integers), a pipeline structure will be described which can be operated with high clock rates despite the allowance of carries. This structure is made possible by using temporary storages which should be inserted in certain equidistant spacings in the binary serial-parallel circuit 1900 (FIG. 19).

The blocks which are produced by inserting the temporary storages (ZS) are termed pipeline stages (PS). The circuit has a quantity “P” of the pipeline stages (PS) having a length “p” in bits. The product p·P=K yields the maximum length of the operands (in bits). The pipeline stages PS may be identical except, e.g., the last stage. In the last stage, the carries of the adder A_{K-1} are collected in an extension of the arithmetic unit (VAE) in two additional D-flipflops using an additional adder A_{K}. In the absence of a successive stage, the temporary storages ZS are no longer necessary in the last stage.

A control unit (SE) is configured upstream of the first pipeline stage PS₁ in which the clock is generated and counted. The control unit SE additionally calculates the supplementation function Con which includes an XOR gate (see FIG. 13), where ρ=2 and N is odd. Moreover, a D-flipflop “FFa” for the temporary storage ZS of the last inserted bit aₜ of the operand a is included in the control unit SE. The first p bits of the operand b are multiplied with the last inserted bit aₜ. Simultaneously, a supplementation with the corresponding supplementation factor iₜ is performed in the first pipeline stage PS₁. A correct result provided once the carries have traveled through (now only) p adders of the first pipeline stage PS₁. This result will be stored in the working memory ZS₁ of the first pipeline stage (in the first p D-flipflops of the working register Reg w), whereas the carries at the output of the p-th adder Aₚ₋₁ of the first pipeline stage are stored in the temporary storage ZS₁.

Each temporary storage ZS includes four D-flipflops: a first D-flipflop Za, a second D-flip-flop Zo₂, a third D-flipflop Zo₁ and a fourth D-flipflop Zi. The first D-flipflop Za stores the bit of the operand a, once the last multiplication has been performed in the pipeline stage. The carries o₂ and o₁ of the last adder in the pipeline stage are stored in the second and the third D-flipflops Zo₂ and Zo₁, whereas the fourth D-flipflop Zi stores the used supplementation factor.

The bits stored in first temporary storage ZS₁ are used in the second pipeline stage PS₂ where the multiplication of the bit aₜ stored in the first D-flipflop Za with the next p bits of the operand b and the corresponding supplementation with iₜ is performed. This may begin when the carries have traveled through p adders of the first pipeline stage PS₁. At the same time the multiplication of aₜ₊₁ with the first p bits of the operand b (and the corresponding supplementation with iₜ₊₁) starts in the first pipeline stage PS₁. Similarly, successive pipeline stages work according to the aforesaid principle and thereby accelerate, depending on the selected length p of the pipeline stages, the work of the binary serial-parallel circuit to a greater (for smaller values of p) or lesser extent (for larger values of p).

In one embodiment, the binary serial-parallel circuit with a pipeline-structure includes 6 functional units: (i) the register Reg a, (ii) the register Reg b, (iii) the register Reg N, (iv) the arithmetic unit (AE) including the chain of adders, the temporary storage ZS and the working register Reg w linked therewith, (v) the clock distribution unit (TVE) which drives the individual pipeline stages using clock distribution stages (TVS), and (vi) the control unit (SE) which generates the clock, counts it and implements all additional control functions (e.g. usual control functions such as, but not limited to, a reset function of the circuit, the start of a particular modular operation, etc.). To ensure a better clarity of the fundamental features, some control functions which can easily be realized are not treated here. In the control unit SE, two multiplexers M₁ and M₂ with three inputs each are includes. These multiplexers M₁ and M₂ play an important role in the implementation of the modular addition and subtraction, which will be described below in further detail.

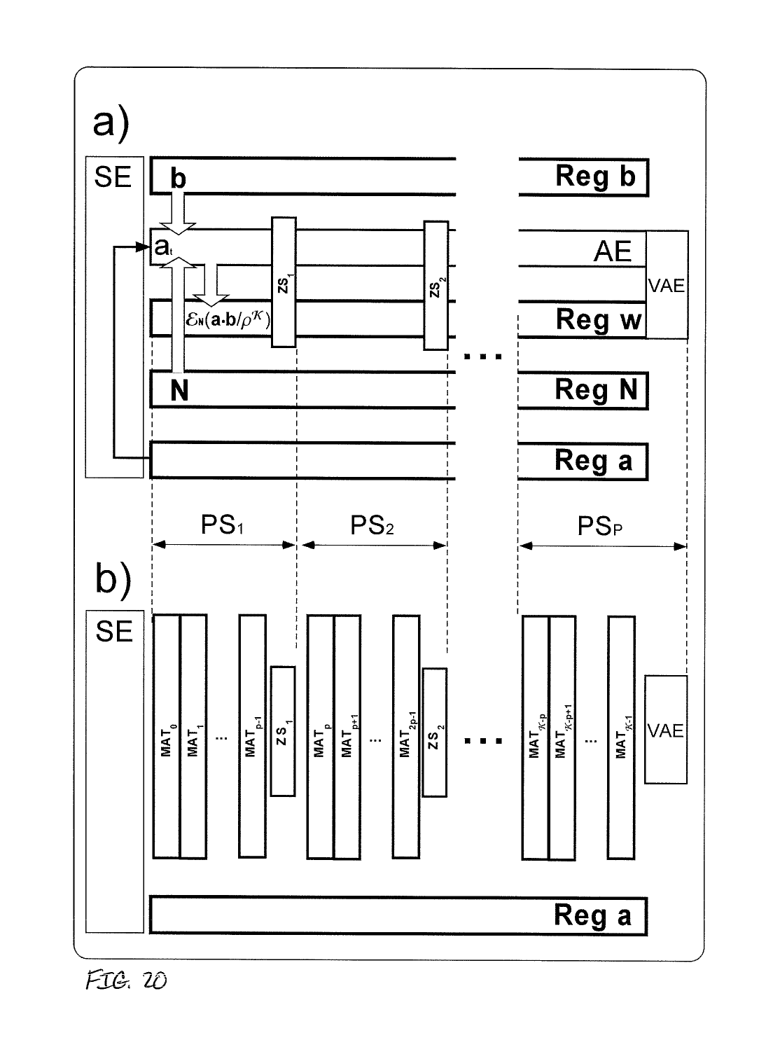

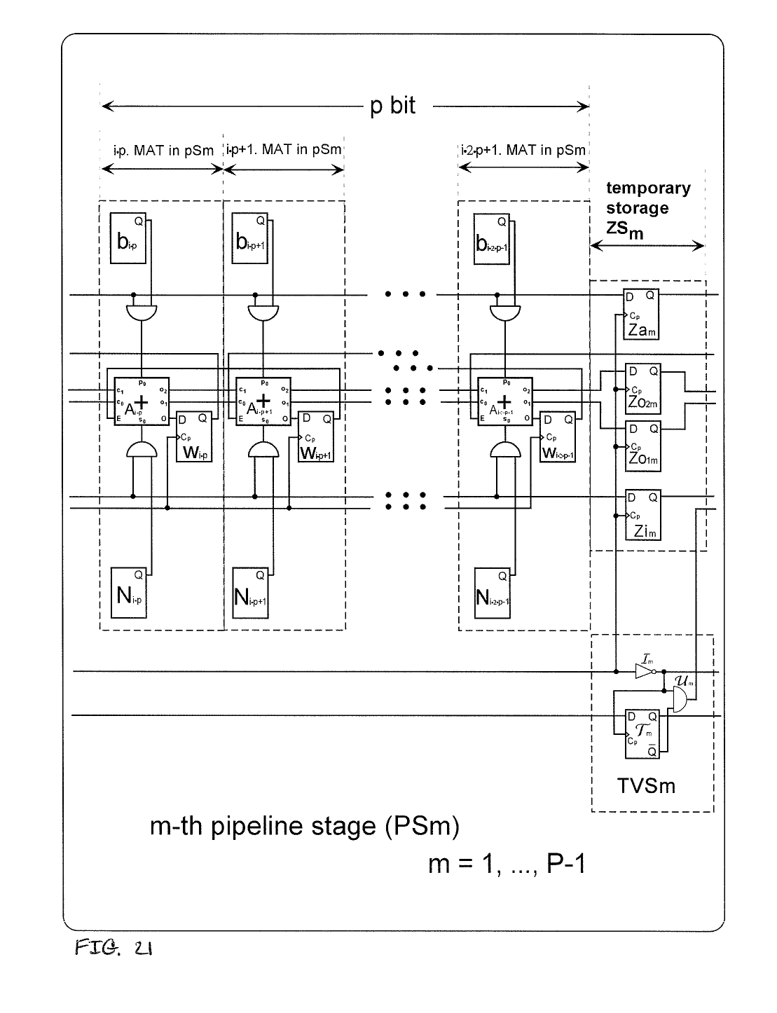

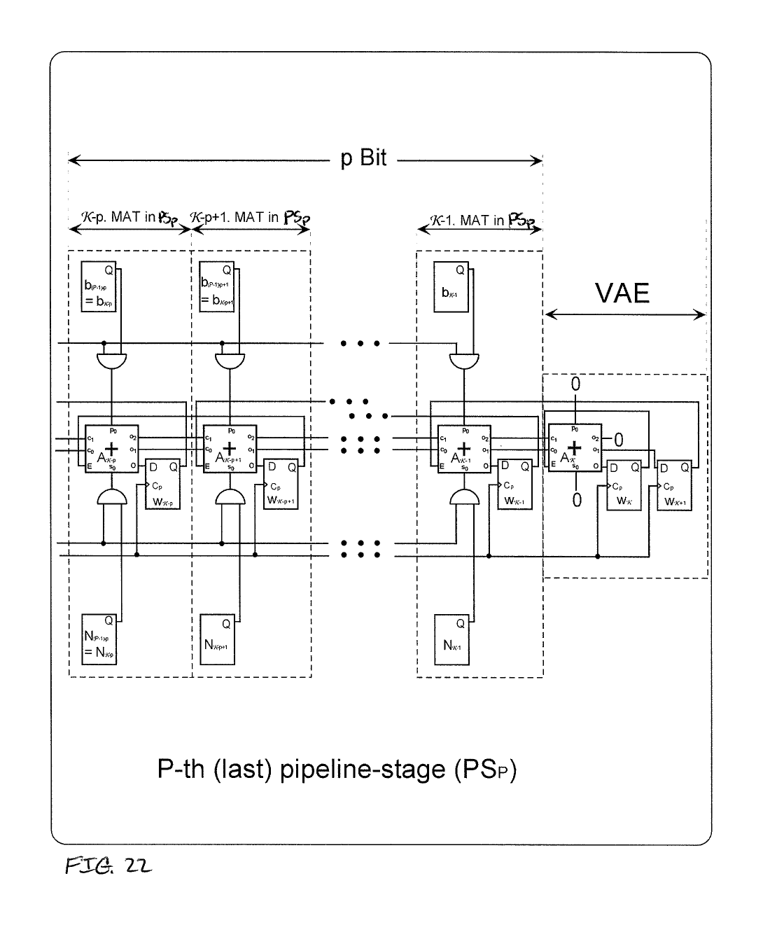

FIG. 19 illustrates the binary serial-parallel circuit 1900, which includes the pipeline structure. FIG. 20A illustrates the circuit in FIG. 19 as a block structure. FIG. 21 is a detailed illustration of one embodiment of the pipeline stage PS. FIG. 22 illustrates the last pipeline stage PS_{P} connected to the arithmetic unit VAE.

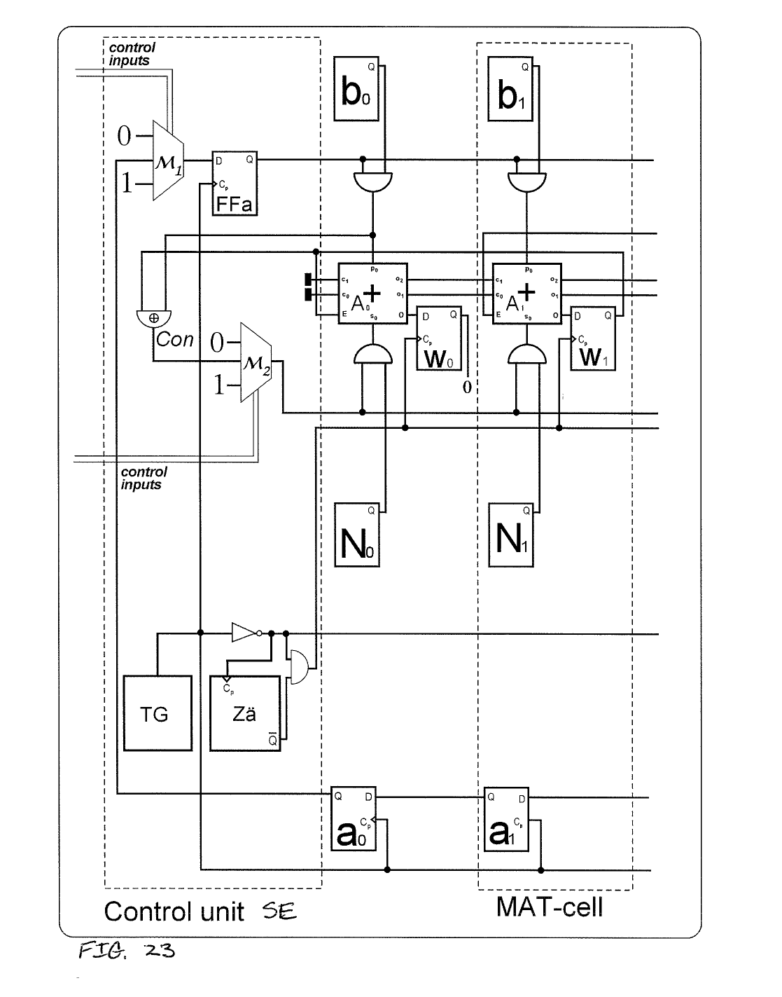

As illustrated in FIG. 21, a pipeline stage PS may also be divided into a serial connection of identical elementary circuits embodying the atomic cells (also referred to as MAT cells) for the calculation of the supplemented product continued fraction E_{N}(a·b/2^{K}) or E_{N(x)}(a(x)·b(x)/x^{K}) for ρ=2. Such a MAT cell multiplies, adds and divides with ρ=2 (see FIG. 23). The block structure of the binary serial-parallel circuit with the pipeline structure based on the MAT cells is illustrated in FIG. 20B. FIG. 23 illustrates, apart from a true-to-detail MAT cell, the control unit SE and its connection with the first pipeline stage PS₁.

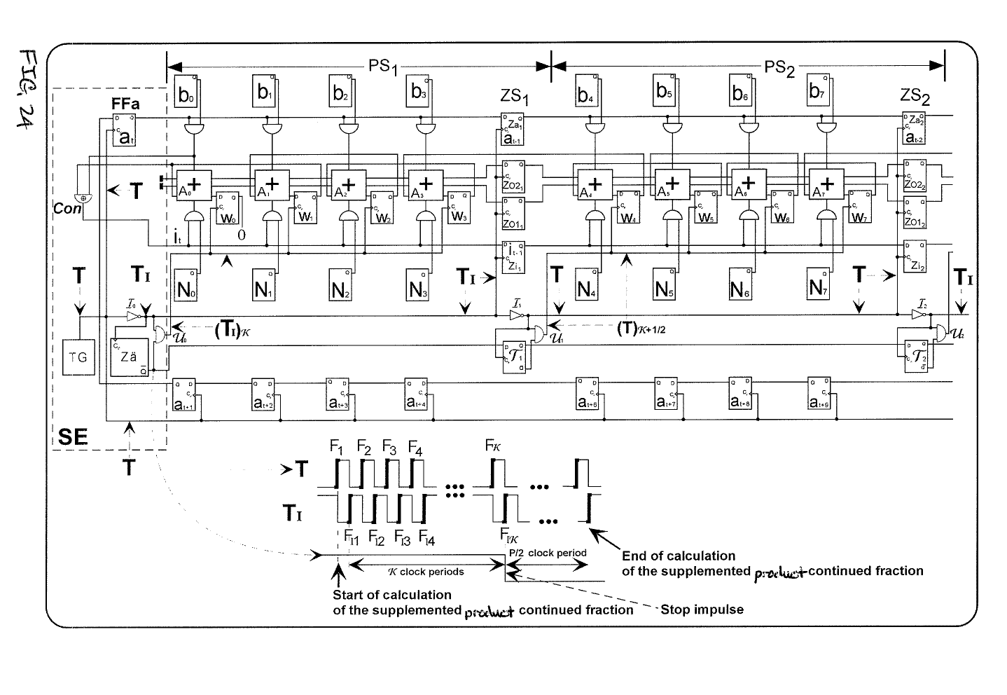

FIG. 24 illustrates the clock distribution with respect to two of a plurality of pipeline stages (PS₁ and PS₂) (e.g., having a length of p=4). As shown in FIG. 21, a clock distribution stage (TVS), which includes one D-flipflop Tₘ, one AND gate Uₘ and one inverter Iₘ, is included in each pipeline stage. The clock distribution stages TVS are similarly configured for all the pipeline stages PS and constitute, in a serial connection, the clock distribution unit (TVE). However, it should be noted that the last pipeline stage PS_{P} does not include a clock distribution stage TVS. The TVE (see FIG. 19) controls the individual pipeline stages to minimize delays in the calculation of the supplemented product continued fraction such that the correct final result can be retained and stored in the work register Reg w at the proper points of time.

Referring to FIG. 24, the D-flipflop FFa (which holds the currently used bit aₜ of the operand a) is clocked with the rising edges (F₁, F₂, . . . , F_{K}) of a clock signal T to calculate the intermediate results in the first pipeline stage PS₁. Since the register Reg a is controlled by the same clock, each rising edge of the clock signal T starts a new intermediate calculation in the first pipeline stage PS₁ with the respectively next bit of the operand a. The rising edges of the clock signal T is offset from the rising edges (F_{I1}, F_{I2}, . . . , F_{IK}) of an inverted clock signal T₁ by half a clock period. During the half clock period, the carries are spread in the addition chain (A₀, A₁, A₂, A₃) of the PS₁ such that the correct intermediate result of the current intermediate calculation (with the bit aₜ) may be forwarded to the working register Reg w. For this reason the D-flipflops w₀ to w₃ of the working register in PS₁ are clocked with the rising edges of the inverted clock signal T₁. The D-flipflops Za₁, Zo2₁, Zo1₁ and Ziₜ of the temporary storage ZS₁ are also clocked with the same edges. The necessary parameters of the intermediate result of the current intermediate calculation in PS₁ as well as the bit aₜ and the supplementation factor iₜ of the next (second) pipeline stage PS₂ are therefore handed over without any further delay. Hence, the second pipeline stage PS₂ can instantly start the intermediate calculations with aₜ and iₜ, whereas the first pipeline stage PS₁ starts the intermediate calculations with aₜ₊₁ and iₜ₊₁. However, in the second pipeline stage PS₂, the D-flipflops w₄ to w₇ of the working register Reg w and of the temporary storage ZS₂ are clocked with the rising edges of the clock signal T (inverse to first pipeline stage PS₁ where the inverse clock signal T_{I} was used for that purpose). This is why the inverse clock signal T_{I} is inverted with I₁ in order to generate a clock signal T in the second pipeline stage PS₂. The third pipeline stage PS₃ is clocked similarly to the first pipeline stage PS₁, the fourth pipeline stage PS₄ is clocked similarly to the second pipeline stage PS₂, etc., continuing up to the last pipeline stage PS_{P}.

After K counted clock periods of the inverse clock period T_{I}, the counter Zä in the control unit (SE) provides a stopping impulse (i.e., falling edge) with the aid of the D-flipflops in the clock distribution unit TVE. The stopping impulse sequentially stops the timing of the individual pipeline stages PS; after each half clock period. Thus, the correct final result is available in the working register Reg w at differing, sequential points in time.

The D-flipflops w₀ to w₃ in the first pipeline stage PS₁ are clocked until the counter Zä in the control unit SE has counted K clock periods starting from the beginning of the calculation of the supplemented product continued fraction (in the inverted clock signal T_{I}). Thereafter, the inverted clock periods are stopped by the AND gate U₀ such that the final result of the first pipeline stage PS₁ is provided to the D-flipflops w₀ to w₃. Referring to FIG. 24, The inverted clock period T_{I} which is stopped after K clock intervals is designated as “(T_{I})_{K}”. In order to collect the final results of the second pipeline stage PS₂ at the right point in time, the clock is stopped after K+½ clock periods by the AND gate U₁ (e.g., the D-flipflop T₁ delays the stopping impulse by half a clock period). This inverted clock which is stopped after K+½ clock periods is designated (T)_{K+1/2} in FIG. 24. The further progress of the clock distribution is performed in the subsequent pipeline stages up to PS_{P} according to the same principle.

When the stopping impulse, which has spread in half clock periods by the clock distribution unit TVE, has stopped the last pipeline stage PS_{P}, a reset process prepares the circuit for a new calculation of the supplemented product continued fraction. Subsequent to the reset process, new operands are stored in their corresponding registers. The calculation of the supplemented product continued fraction is controlled by the control unit SE using the clock distribution described above.

The previously described binary serial-parallel circuit (see FIG. 24) including the pipeline structure for the calculation of the supplemented product continued fraction E_{N}(a·b/2^{K}) or (with polynomials) E_{N(x)}(a(x)·b(x)/x^{K}) with odd modulus may be extended using simple measures by the modular addition R_{N}[a+b] and modular subtraction R_{N}[b−a]. These measures are also required for the final corrective subtraction of the modulus N according to equation (32) for the evaluation of the continued fraction transformation.

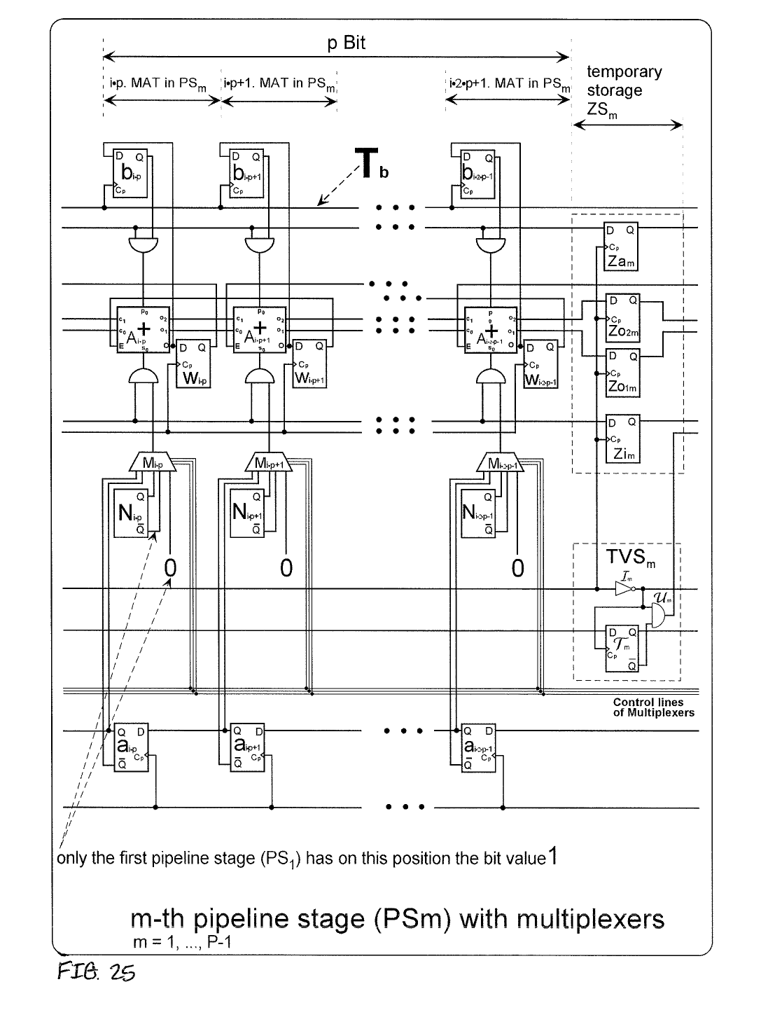

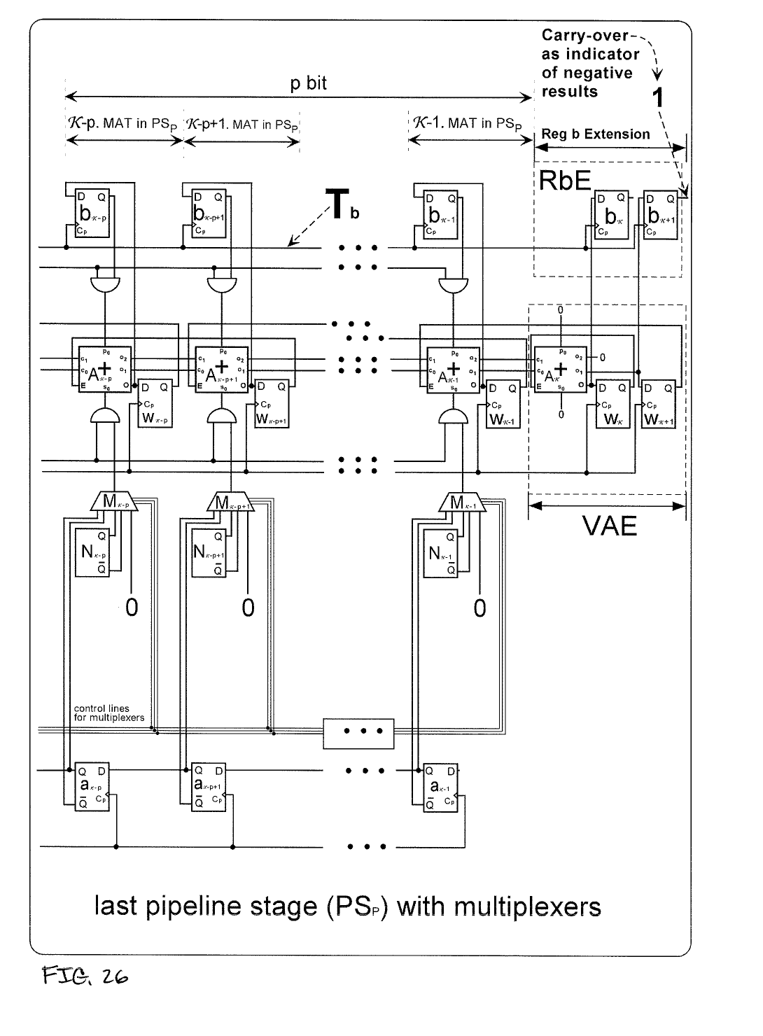

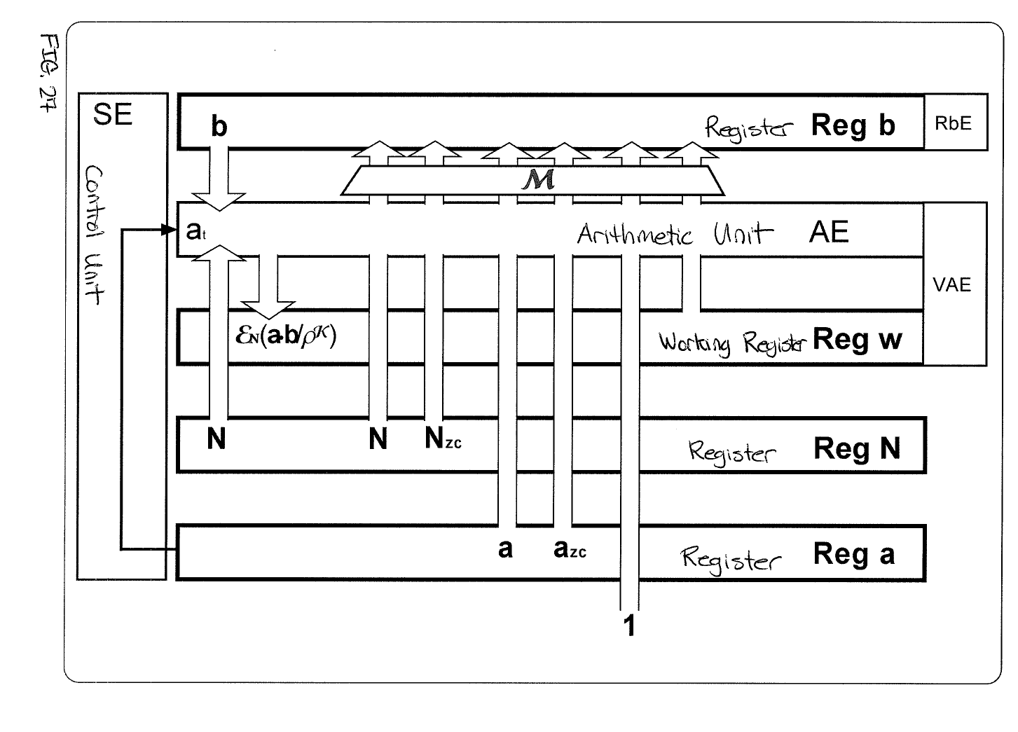

To this end an additional series of multiplexers M={Mₘ; (m=1, . . . , K)}, each having five inputs, allow parallel access to the operand a, its complement a_{c}, the modulus N, its complement on two N_{zc}, and to the constant 1=(00 . . . 001)₂. As set forth above, the operand b is available in parallel to the operand a. A connection between the outputs of the adders A₀, . . . , A_{K} and the register Reg b is provided to receive the results of addition, subtraction and multiplication. The multiplication results are received via the final corrective subtraction of the modulus according to equation (32) during the evaluation of the continued fraction (inverse) transformation. FIG. 25 shows the extensions within one pipeline stage PSₘ; m=2, . . . , (P−1). The extensions are identical except for the first and the last pipeline stages PS₁ and PS_{P-1}. FIG. 26 illustrates the small differences between the pipeline extensions PSₘ m=2, . . . , (P−1) and the first pipeline extension PS₁ in FIG. 25. FIG. 27 illustrates the register structure of the entire extended circuit and shows which arguments are available in parallel form and which registers are loadable in a parallel fashion (e.g., via the chain of adders).

The modular addition R_{N}[b+a] may be started simply by the parallel selection of the operand a via the series of multiplexers M, by supplying a bit with the value 1 in the D-flipflop FFa via the multiplexer M₁ and by selecting a bit with the value 1 via the multiplexer M₂ in control unit SE. Using this process, only a part of the intermediate result b+a of R_{N}[b+a] is written in the register Reg b of the first pipeline stage PS₁. Using P−1 half clock periods, the bits having the value 1 at the outputs of the multiplexers M₁ and M₂ are shifted through D-flipflops Zaₘ and Ziₘ with the aid of the clock distribution unit TVE, thus b+a is fully received in the register Reg b. In this process, the counter Zä counts to 1 (e.g., and not to K as for the calculation of the supplemented product continued fraction). For the calculation of b+a, the work register Reg w is reset (e.g., its content being set to 0) and is not clocked. Instead, the register Reg b is provided with a clock port T_{b} in order to be able to adopt the result b+a in the individual pipeline stages in a parallel fashion.

The sum b+a which is thereby accrued in the register Reg b might possibly be larger than the modulus, and therefore N is subtracted, e.g., once at the most (because a<N and b<N was assumed). The complement on two N_{zc} of the modulus is added to the content (b+a) of the register Reg b. The complement on two of odd numbers, such as the modulus N, can be obtained through a bit-by-bit inversion of the particular bits and setting the LSB to 1. The complement on two will have already been provided and it can simply be selected via the multiplexers M={Mₘ; (m=1, . . . , K)}. By supplying a bit with the value 1 in the D-flipflop FFa via the multiplexer M₁, and by selecting a bit with the value 1 via the multiplexer M₂ in the control unit SE, the addition (b+a)+N_{zc} is started and is obtained in the register Reg b after P half clock periods (as for the case b+a).

Where the content (b+a) in the register Reg b is larger than N, the decision to subtract the modulus may need to be verified. Absent including a sophisticated word comparator, the verification problem may be solved by using a trial-and-error technique. In this technique, the modulus N is subtracted, e.g., once in any case according to the technique described above. Where the intermediate result b+a is smaller than the modulus, an overflow is generated in the K+1-th bit of the register Reg b (register Reg b is extended by two bit positions, see RbE in FIG. 26). Here, the overflow may easily be detected. Where an overflow has occurred, the modulus N is added up again via a selection by the multiplexer M.

Similarly, the modular subtraction R_{N}[b−a] is performed by adding the complement on two a_{zc} from a to b. However, the calculation of this complement on two is more difficult since it may not be possible to assume that a is odd. Therefore, the addition of the complement on two has to be segmented into an addition of the bit-by-bit complement a_{c} (which is simple to obtain) and of the constant 1. The multiplexers M offer this possibility (see FIG. 27).

Where the equality a>b is true (i.e., the subtraction yielded a negative intermediate result identifiable at the overflow in the K+1-th bit of Reg b), the modulus is re-added to the content of the register Reg b.

The corrective subtraction according to equation (32) in the evaluation of the continued fraction transformation is, as with the modular addition, may be performed using the trial-and-error technique. Following the evaluation of the supplemented product continued fraction, the content of the working register Reg w (where the result of the supplemented product continued fraction is stored) is copied into the operand register Reg b. This is carried out like an addition, but the outputs of the two multiplexers M₁ and M₂ are set to the value 0. Afterwards and where necessary, the modulus N is subtracted using the trial-and-error technique, as described above.

In the polynomial case, the only difference to the circuit described above is the function of the adders {Aₘ}. In this case, the adders do not execute an addition with carry, but an XOR of their operands. Such an adjustable adder has been shown in, e.g., FIG. 13. Depending on the inputs, it should be noted that the modular addition may have extended runtimes in the polynomial case. For example, it is necessary to run through the entire pipeline—even where this does not render any added value due to the missing carries. For this reason a modular addition also uses the P/2 clock periods in the polynomial case.

The circuit describe above does not consider inversion or division because it (as described above) may be performed with the aid of Fermat's little theorem by a multiple multiplication. The same applies for a modular exponentiation with a natural number, which may be performed, e.g., by the square-and-multiply technique.

The extensions to other modular basic operations for the previously presented parallel circuits are principally identical with the binary serial-parallel circuit which is treated here. All processes in the evaluation of the supplemented product continued fraction as well as in the modular addition, subtraction, exponentiation with a natural number and division may be made using of a relatively simple finite control machine included in the control unit SE (FIG. 23). Alternatively, an external processor which takes on this task may be used. The binary serial-parallel circuit including the pipeline structure therefore allows a very efficient implementation of the modular arithmetic both for integers and for polynomials over Z₂[x]_{N(x)}, thereby fulfilling the demand of a complete circuit.

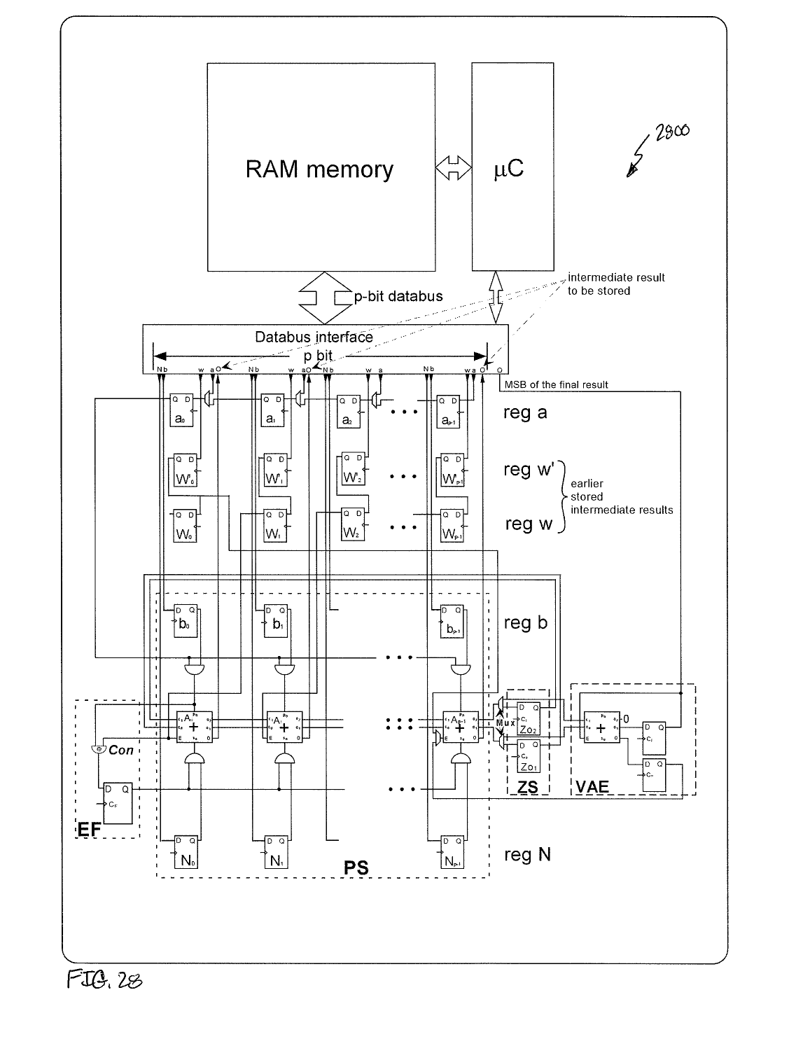

Apart from parallel and serial-parallel embodiments which have been described above, the continued fraction transformation may also be implemented in serial fashion. This implementation may use merely one pipeline stage (PS) whose length is adapted to the width of the data bus. Referring to circuit 2800 in FIG. 28, in the binary case, the pipeline stage PS is supplemented by a supplementation function unit EF, a temporary storage ZS and an extension of the arithmetic unit (VAE). All operands and intermediate results are latched in a RAM (“Random Access Memory”) memory which is controlled by a microcontroller μC. The intermediate results from the pipeline stage PS are provided directly to the RAM memory via the data bus interface, for example where the pipeline stage PS does not include a working register Reg w. Due to the shifting by one bit (division by 2), two appropriate intermediate results from the calculation of a supplemented numerator Zₙ′ of the supplemented product continued fraction are stored in the RAM memory, which already have been stored there during the calculation of the numerator Zₙ₋₁′. These are taken from the RAM memory and put into the working registers reg w′ and reg w. At the beginning of the calculation of Zₙ∝, two appropriate intermediate results are immediately shifted to the working registers reg w′ and reg w. In the further progress of the calculation of Zₙ′, one intermediate result is brought from the RAM memory to the work register reg w′, as the other intermediate result from the work register reg w′ can be relocated in the work register reg w in advance. The carries stored in ZS at the end of the pipeline stage PS are accepted via the feed-back from the adder A₀ for the next calculation. At the end of the calculation of Zₙ′, the arithmetic unit VAE remains switched on via the multiplexers Max to calculate the MSB of Zₙ′. Blocks of the operands a are also taken from the RAM memory and put into the register reg a, where the particular bits aₙ are serially introduced into the calculation of Zₙ′.

The presented binary serial circuit for the calculation of the supplemented product continued fraction E_{N}(a·b/2^{K}) or E_{N(x)}(a(x)·b(x)/x^{K}) with odd modulus (N₀=1) is particularly suitable for space-saving circuits such as sensors or RFIDs.

It has been demonstrated that the continued fraction transformation is also flexible in terms of implementation. It can be employed as a discrete circuit, as a circuit which is controlled by a microcontroller, or even as a autonomous software module for a microcontroller.

Although the present invention has been illustrated and described with respect to several preferred embodiments thereof, various changes, omissions and additions to the form and detail thereof, may be made therein, without departing from the spirit and scope of the invention.

What is claimed is:

1. A method for performing a calculation, where in a first case the calculation is a modular multiplication R_{N}[ab] of integers for a modulus N, where the integers a and b, which are less than the modulus N, and the modulus N are presented using a radix ρ, and where in a second case the calculation is a modular multiplication R_{N(x)}[a(x)b(x)] of polynomials for a modulus polynomial N=N(x), where the polynomials a=a(x) with degree(a(x))<degree(N(x)) and b=b(x) with degree(b(x))<degree(N(x)) and the modulus polynomial N(x) are presented using powers of a free variable x and coefficients from a ring Z_{M} of integers modulo M, the method comprising:
calculating a supplemental product continued fraction c=(ab+jN)/t by supplementing particular numerators of a product fraction (ab)/t represented as a continued fraction, where in the first case c and j are integers and t=ρ^{K}, where in the second case c=c(x) and j=j(x) are polynomials having coefficients from the ring Z_{M} and t=t(x)=x^{K}, and where in the first and the second cases K is an integer greater than or equal to a length Λρ(a) of the operand a which is broken down in the continued fraction; and
calculating a second supplemental product continued fraction r=(cd+kN)/t from a previously calculated modular remainder d=R_{N}[t²] and the calculated supplemental product continued fraction c, where in the first case r, k and d are integers, where in the second case r=r(x)=R_{N(x)}[a(x)b(x)], k=k(x) and d=d(x) are polynomials having coefficients from the ring Z_{M}.

2. The method of claim 1, further comprising
verifying in each case whether the calculated supplemented product continued fractions c and r are smaller than the modulus N; and
subtracting the modulus N for a number of times until the supplemented product continued fractions c and r are smaller than the modulus N where the supplemented product continued fractions c and r are greater than the modulus N.

3. A circuit for modular arithmetic with at least one unit for calculating and supplementing particular numerators of a product fraction ab/t presented as a continued fraction using a radix ρ, comprising:
a register Reg b having K register cells (b₀, b₁, . . . , b_{K-1}) for all digits of a multiplicand b;
a register Reg N having K register cells (N₀, N₁, . . . , N_{K-1}) for all digits of a modulus N;
at least one of
(i) a working register Reg w having K+2 work register cells (w₀, w₁, . . . , w_{K+1}); and
(ii) a working memory which is accessible through a data bus interface having a width of p bits, and a microprocessor which controls and supervises the working memory and the data bus interface;
a memory cell a₀ for a digit of a multiplicand a;
a memory cell i₀ for a supplementation factor;
K multipliers (Mb₀, Mb₁, . . . Mb_{K-1}) that multiply digits (b₀, b₁, . . . , b_{K-1}) with a digit of the multiplicand a;
K multipliers (MN₀, MN₁, . . . MN_{K-1}) that multiply digits (N₀, N₁, . . . , N_{K-1}) with the supplementation factor; and
K adders (A₀, A₁, . . . , A_{K-1}) that add particular results of the multiplication with a digit of the multiplicand a and the multiplication with the supplementation factor, each adder Aₖ having a plurality of inputs;
where if ρ≠2
a first input of the multiplier Mbₖ is connected with the output of the register cell bₖ, a second input of the multiplier Mbₖ is connected with the output of the memory cell a₀, and two outputs of the multiplier Mbₖ are each connected with one of the inputs of the adder Aₖ;
a first input of the multiplier MNₖ is connected with the output of the register cell Nₖ, a second input of the multiplier MNₖ is connected with the output of the memory cell i₀, and two outputs of the multiplier MNₖ are each connected with one of the inputs of the adder Aₖ;
a first output of the adder Aₖ is connected with the work register cell wₖ, and where k<K−1 two other outputs of the adder Aₖ are each connected with one of the inputs of the adder A_{K+1}; and
a first output of the adder A_{K-1} is connected with an input of the work register cell w_{K} and a second output of the adder A_{K-1} is connected with an input of the register cell w_{K+1}; and
where if ρ=2
the first input of the multiplier Mbₖ is connected with the output of the register cell bₖ, the second input of the multiplier Mbₖ is connected with the output of the memory cell a₀, and two outputs of the multiplier MNₖ are connected with one of the inputs of the adder Aₖ;
the first input of the multiplier MNₖ is connected with the output of the register cell Nₖ, the second input of the multiplier MNₖ is connected with the output of the memory cell i₀ and an output of the multiplier MNₖ is connected with one of the inputs of the adder Aₖ;
the first output of the adder Aₖ is connected with the work register cell wₖ, for and where k<K−1 the two other outputs of the adder Aₖ are each connected with one of the inputs of the adder A_{K+1}; and
the first output of the adder A_{K-1} is connected with the input of the work register cell w_{K} and second output of the adder A_{K-1} is connected with the input of the register cell w_{K+1};
characterized in that the circuit has a circuit Con for determining the supplementation factor for the supplementation of numerators of the product continued fraction, the output of the multiplier Mb₀ being additionally connected with inputs of the circuit Con and one output of the circuit Con being connected with an input of the memory cell i₀.

4. The circuit of claim 3, where the working register Reg w includes K+2 work register cells w₀, w₁, . . . , w_{K+1}.

5. The circuit of claim 4, where the adders Aₖ (k=0, 1, . . . K−1) have a separate input for each input digit of the double-digit values (c₁c₀), (p₁p₀), (s₁s₀) fed into them and for a single-digit value E fed into them, and three digit outputs (o₂o₁O) are provided for each adder to deliver a result of a calculation (o₂o₁O)=c₁c₀+p₁p₀+s₁s₀+E given by a digit-wise addition of the digits c₀,p₀,s₀, E with carry-over followed by a digit-wise addition of the digits c₁,p₁,s₁ and the carry-over.

6. The circuit of claim 4, where ρ=2 and the multipliers Mbₖ and MNₖ (k=0, 1, . . . K−1) comprise AND gates.

7. The circuit of claim 4, where ρ=2 and the adders Aₖ (k=0, 1, . . . K−1) comprise XOR gates.

8. The circuit of claim 4, where ρ=2 and the circuit Con comprises an XOR gate.

9. The circuit of claim 4, where the outputs of the work register cells wₖ are connected with inputs of the adder Aₖ′ of an additional circuit for modular arithmetic such that, where k>0, the output of the work register cell wₖ is connected with one of the inputs of the adder Aₖ₋₁′ and the output of the work register cell w₁ is additionally connected with the circuit Con.

10. The circuit of claim 4, further comprising:
a register Reg a having K cells (a₀, . . . , a_{K-1}), where the memory cell a₀ is integrated as a first memory cell of the register Reg a; and
an internal clock for driving the register Reg a and the working register Reg w;
where the outputs of the working register cells wᵣ are connected with inputs of adder Aᵣ such that where r>0 the output of the working register cell wᵣ is connected with an input of the adder Aᵣ₋₁ and the output of the working register cell w₁ is additionally connected with the circuit Con.

11. The circuit of claim 10, further comprising temporary storage cells Zaₘ, ZO₂ₘ, ZO₁ₘ and Zᵢₘ, where the circuit is separated into pipeline stages which each include the same number of register cells and are inserted in the circuit such that storage of the bits of operand a, where a last multiplication in the pipeline stage is performed in the temporary storage cell Zaₘ, where storage of generated carry-overs o₂ and o₁ occurs in the temporary storage cells ZO₂ₘ and ZO₁ₘ, and where storage of used supplementation factor occurs in the temporary storage cell Zᵢₘ.
